(19) United States
(12) Patent Application Publication
(10) Pub. No.: US 2006/0092495 A1
(43) Pub. Date: May 4, 2006

(54) Anti-glare anti-reflection film, polarizing plate, and image display device

(75) Inventor: Yuuzou Muramatsu, Minami-Ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: FUJI PHOTO FILM CO., LTD., Minami-Ashigara-shi (JP)

(21) Appl. No.: 11/258,152

(22) Filed: Oct. 26, 2005

(30) Foreign Application Priority Data
Oct. 28, 2004 (JP) P2004-314057

(51) Int. Cl. G02F 1/153

(52) U.S. Cl. 359/275

(57) ABSTRACT

An anti-glare anti-reflection film comprises an anti-glare layer and at least one low refractive index layer provided on or above a transparent support, wherein the anti-glare layer is a layer formed by spreading a coating composition for anti-glare layer, the coating composition for anti-glare layer to be spread comprises a polymer compound and the coating composition for anti-glare layer shows a viscosity rise of 3 mPa·s to 10 mPa·s due to the incorporation of the polymer compound.

### BACKGROUND OF THE INVENTION

1. Field of the Invention

The present invention relates to an anti-glare anti-reflection film and a polarizing plate and an image display device comprising same.

2. Description of the Related Art

The recent trend is for more liquid crystal display devices to have a larger screen and thus comprise optically functional films such as anti-reflection film provided thereon.

An anti-reflection film is disposed on the surface of the screen of various image display devices such as liquid crystal display device (LCD), plasma display panel (PDP), electroluminescence display (ELD) and cathode ray tube display (CRT) to prevent the drop of contrast due to the reflection of external light rays or image. As a method of providing the anti-reflection film with anti-reflection properties, an anti-glare layer may be provided. By incorporating a light-transmitting particulate material in this layer, anti-glare properties and other properties can be developed as one of effects. The anti-glare properties depend greatly on the surface shape of the anti-reflection film. The light-transmitting particulate material contained in the anti-glare layer causes the rise of surface roughness to scatter reflected light and hence eliminate reflection of image. It is also practiced to provide a low refractive index layer on the anti-reflection film for the purpose of reducing the amount of reflected light rays in addition to the anti-glare effect. However, an optical film comprising a plurality of transparent functional layers may have adhesivity problems. In order to overcome these problems, it is occasionally practiced to incorporate a certain kind of a transparent polymer compound in the related layers (JP-A-2001-83327).

It has recently been made obvious that one of the factors causing the rise of surface roughness is intralayer dispersibility (or cohesiveness) of light-transmitting particulate material and this factor depends on the physical properties of the coating solution for forming the anti-glare layer (JP-A-2001-281407).

The inventors' studies show that the polymer compounds as used in JP-A-2001-83327 are effective to control these physical properties. On the other hand, it was also made obvious that mere use of these polymer compounds cannot provide a sufficient improving effect, specific polymer compounds are effective particularly for the control over specific physical properties. It was further made obvious that other materials to be used in combination with these specific polymer compounds should be selected and used to enhance the intralayer diffusion effect.

On the other hand, a polarizing plate is an optical material indispensable for liquid crystal display devices. In general, a polarizing plate comprises a polarizing layer protected by two sheets of protective film.

When these protective films can be provided with anti-reflection properties, drastic reduction of cost and thickness of display devices can be attained.

The protective film to be incorporated in a polarizing plate needs to have an adhesivity high enough to stick to the polarizing layer. As a method of enhancing the adhesivity to the polarizing layer, it is normally practiced to saponify the protective film so that the surface of the protective film is hydrophilicized.

### SUMMARY OF THE INVENTION

An aim of the invention is to stably provide an anti-reflection film having excellent anti-glare properties and good coat surface conditions.

Another aim of the invention is to provide a polarizing plate which is subjected to anti-reflection treatment by a proper means and an image display device comprising same.

The aforementioned aims of the invention are accomplished with the anti-glare anti-reflection film, polarizing plate and image display device having the following constitutions.

1. An anti-glare anti-reflection film comprising an anti-glare layer and at least one low refractive index layer provided on or above a transparent support, wherein the anti-glare layer is a layer formed by spreading a coating composition for anti-glare layer, the coating composition for anti-glare layer to be spread contains a polymer compound and the coating composition for anti-glare layer shows a viscosity rise of 3 mPa·s to 10 mPa·s due to the incorporation of the polymer compound.

2. The anti-glare anti-reflection film as defined in Clause 1, wherein the anti-glare layer is formed by spreading a coating composition for anti-glare layer having a viscosity of from 6 mPa·s to 20 mPa·s containing a polymer compound.

3. The anti-glare anti-reflection film as defined in Clause 1 or 2, wherein the polymer compound is one having a weight-average molecular weight of from 5,000 to 600,000.

4. The anti-glare anti-reflection film as defined in any one of Clause 1 to 3, wherein the polymer compound is one having a weight-average molecular weight of from 5,000 to 200,000.

5. The anti-glare anti-reflection film as defined in any one of Clauses 1 to 4, wherein the polymer compound is a copolymer.

6. The anti-glare anti-reflection film as defined in any one of Clauses 1 to 5, wherein the polymer compound is incorporated in an amount of from 5% to 30% by mass based on the total weight of the binders incorporated in the layers containing the polymer compound.

7. The anti-glare anti-reflection film as defined in any one of Clauses 1 to 6, wherein the polymer compound is a (meth)acrylic resin.

8. The anti-glare anti-reflection film as defined in any one of Clauses 1 to 6, wherein the polymer compound is a cellulose ester-based resin.

9. The anti-glare anti-reflection film as defined in any one of Clauses 1 to 6, wherein the polymer compound is a vinyl-based resin.

10. The anti-glare anti-reflection film as defined in any one of Clauses 1 to 9, wherein the polymer compound-containing layer is an anti-glare layer containing a light-transmitting particulate material having a particle diameter of from 1 μm to 8 μm, the refractive index of the binder matrix in the anti-glare layer is from 1.45 to 1.90 and the difference in refractive index between the binder matrix and the light-transmitting particulate material in the anti-glare layer is from 0.02 to 0.30.

11. The anti-glare anti-reflection film as defined in any one of Clauses 1 to 10, wherein the polymer compound-containing layer is an anti-glare layer containing a light-transmitting particulate material having a particle diameter of from 1 μm to 8 μm, the thickness of the anti-glare layer is from 3 μm to 10 μm and the average particle diameter of the light-transmitting particulate material in the anti-glare layer falls within a range of from 30% to 80% of the thickness of the anti-glare layer.

12. The anti-glare anti-reflection film as defined in any one of Clauses 1 to 11, wherein any of the layers on the transparent support contains at least any of organosilane compounds represented by the following general formula (a) and derivatives thereof:
(R¹⁰)_{S}—Si(Z)_{4-S} (a)
wherein R¹⁰ represents a substituted or unsubstituted alkyl or aryl group; Z represents a hydroxyl group or hydrolyzable group; and s represents an integer of from 1 to 3.

13. The anti-glare anti-reflection film as defined in any one of Clauses 1 to 12, wherein the low refractive index layer is formed by the crosslinking or polymerization reaction of a fluorine-containing compound represented by the following general formula (1): 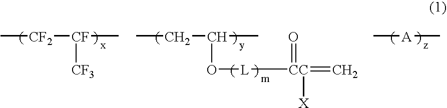
wherein L represents a connecting group having from 1 to 10 carbon atoms; m represents 0 or 1; X represents a hydrogen atom or methyl group; A represents an arbitrary vinyl monomer polymerizing unit which may be a single polymerizing unit or may comprise a plurality of polymerizing units; and x, y and z each represent a molar percentage of a respective constituent polymerizing unit, with the proviso that x, y and z satisfy relationships 30≦x≦60, 5≦y≦70 and 0≦z≦65.

14. The anti-glare anti-reflection film as defined in Clause 13, wherein the low refractive index layer contains a hollow particulate silica.

15. A process for the production of an anti-glare anti-reflection film as defined in any one of Clauses 1 to 14, comprising:

(1) preparing a coating composition for anti-glare anti-reflection layer as a coating composition having a viscosity of from 3 mPa·s to 10 mPa·s; and

(2) adding a polymer compound to the coating composition to raise the viscosity thereof by 3 mPa·s to 10 mPa·s from before the addition.

16. A polarizing plate comprising an anti-glare anti-reflection film defined in any one of Clauses 1 to 14 as at least one of two sheets of protective films for polarizing layer.

17. An image display device comprising an anti-glare anti-reflection film as defined in any one of Clauses 1 to 14 or a polarizing plate as defined in Clause 16 disposed on the image display surface thereof

18. The image display device as defined in Clause 17, which is a TN, STN, IPS, VA or OCB mode transmission, reflection or semi-transmission type liquid crystal display device.

### DETAILED DESCRIPTION OF THE INVENTION

In the present specification, in the case where the numerical values indicate physical values, properties or the like, the term “(value 1) to (value 2)” as used herein is meant to indicate “not smaller than (value 1) to not greater than (value 2)”. The term “(meth)acryloyl” as used herein is meant to indicate “at least any of acryloyl and methacryloyl”. This can apply to “(meth)acrylate”, “(meth)acrylic acid”, etc.

The invention will be further described hereinafter.

In accordance with the anti-reflection film of the invention, the anti-glare layer constituting the anti-reflection film is a layer formed by raising the viscosity of a coating solution (coating composition) for anti-glare layer by 3 mPa·s to 10 mPa·s before the addition, and then spreading the coating solution.

The aforementioned anti-glare layer will be described hereinafter.

(Anti-Glare Layer)

The anti-glare layer is formed by a main binder composed of a light-transmitting polymer formed by irradiating monomers with ionizing radiation, etc., a light-transmitting particulate material, a finely divided inorganic filler for enhancing or lowering refractive index, preventing crosslink condensation and enhancing intensity and a polymer compound.

The thickness of the anti-glare layer is normally from about 0.5 μm to 30 μm, preferably from 1 μm to 15 μm, more preferably from 3 μm to 10 μm. When the thickness of the anti-glare layer falls within the above defined range, there occur no defects such as curling, haze and cost rise. Further, the anti-glare properties and the light diffusing effect can be easily adjusted.

(Main Binder)

The main binder constituting the anti-glare layer is preferably a light-transmitting polymer which has a saturated hydrocarbon chain or polyether chain, more preferably saturated hydrocarbon chain as a main chain when cured, e.g., by irradiation with ionizing radiation. The main binder thus cured preferably has a crosslinked structure.

The binder polymer which has a saturated hydrocarbon chain as a main chain when cured is preferably a polymer of ethylenically unsaturated monomers (binder precursor). The binder polymer having a saturated hydrocarbon chain as a main chain and a crosslinked structure is preferably a (co)polymer of monomers having two or more ethylenically unsaturated groups.

In order to provide a higher refractive index, the structure of the monomer preferably contains an aromatic ring or at least one atom selected from the group consisting of halogen atoms other than fluorine, sulfur atom, phosphorus atom and nitrogen atom.

Examples of the monomer having two or more ethylenically unsaturated groups for forming the anti-glare layer include esters of polyvalent alcohols with (meth)acrylic acids (e.g., ethylene glycol di(meth)acrylate, 1,4-cyclohexane diacrylate, pentaerythritol tetra(meth)acrylate, pentaerythritol tri(meth)acrylate, trimethylolpropane tri(meth) acrylate, trimethylolethane tri(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-chlorohexane tetramethacrylate, polyurethane polyacrylate, polyester polyacrylate), vinylbenzene and derivatives thereof (e.g., 1,4-vinylbenzene, 4-vinylbenzoic acid-2-acryloylethylester, 1,4-vinylcyclohexanone), vinylsulfones (e.g., divinylsulfone), acrylamides (e.g., methylene bisacrylamide), and methacrylamides.

Further examples of the aforementioned monomers include resins having two or more ethylenically unsaturated groups such as relatively low molecular polyester resin, polyether resin, acrylic resin, epoxy resin, urethane resin, alkyd resin, spiroacetal resin, polybutadiene resin and polythiolpolyene resin, and oligomers and prepolymers of polyfunctional compounds such as polyvalent alcohol. These monomers may be used in combination of two or more thereof. The resins having two or more ethylenically unsaturated groups are preferably incorporated in an amount of from 10% to 70% based on the total amount of the binders.

Specific examples of the high refraction monomers include bis(4-methacryloylthiophenyl)sulfide, vinyl naphthalene, vinyl phenyl sulfide, and 4-methacryloxy phenyl-4′-methoxyphenylthioether. These monomers, too, may be used in combination of two or more thereof.

The polymerization of these monomers having ethylenically unsaturated groups may be carried out by irradiation with ionizing radiation or heating in the presence of a photoradical polymerization initiator or heat radical polymerization initiator.

Accordingly, a curable composition containing a monomer having an ethylenically unsaturated group, a photoradical polymerization initiator or heat radical polymerization initiator, a particulate mat, an inorganic filler and other additives is prepared. The curable composition is spread over a transparent support, and then irradiated with ionizing radiation or heated to undergo polymerization reaction and curing leading to the formation of an anti-reflection film. It is also preferred that irradiation with ionizing radiation and thermosetting be effected in combination.

The refractive index of the binder is preferably from 1.40 to 2.00, more preferably from 1.45 to 1.90, even more preferably from 1.48 to 1.85, particularly from 1.51 to 1.80. The refractive index of the binder is measured on the component of the light-diffusing layer excluding the light-transmitting particulate material.

The binder of the anti-glare layer is preferably added in an amount of from 20% to 95% by mass based on the solid content of the coating composition in the anti-glare layer.

The refractive index can be measured by Abbe refractometer (light source: 590 nm, 20° C.) (manufactured by ATAGO CO., LTD) or the like.

Examples of the photoradical polymerization initiator employable herein include acetophenones, benzoins, benzophenones, phosphine oxides, ketals, anthraquinones, thioxanthones, azo compounds, peroxides, 2,3-alkyldione compounds, disulfide compounds, fluoroamine compounds, and aromatic sulfoniums. Examples of the acetophenones include 2,2-ethoxyacetophenone, p-methylacetophenone, 1-hydroxydimethylphenylketone, 1-hydroxycyclohexyl phenylketone, 2-methyl-4-methylthio-2-morpholino propiophenone, and 2-benzyl-2-diemtylamino-1-(4-morpholinophenyl-butanone. Examples of the benzoins include benzoinbenzenesulfonic acid ester, benzoin toluenesulfonic acid ester, benzoinmethyl ether, benzoinethyl ether, and benzoin isopropyl ether. Examples of the benzophenones include benzophenone, 2,4-chlorobenzophenone, 4,4-dichlorobenzophenone, and p-chlorobenzophenone. Examples of the phosphine oxides include 2,4,6-trimethylbenzoyl diphenyl phosphine oxide.

Various examples are disclosed also in Kazuhiro Takausu, “Saishin UV Koka Gijutsu (Modern UV-curing Technique)”, TECHNICAL INFORMATION INSTITUTION CO., LTD., page 159, 1991.

Preferred examples of commercially available photo-cleavable photoradical polymerization initiators include Irgacure (651, 184, 907), produced by Ciba Specialty Chemicals Co., Ltd.

The photopolymerization initiator is preferably used in an amount of from 0.1 to 15 parts by mass, more preferably from 1 to 10 parts by mass based on 100 parts by mass of polyfunctional monomer.

In addition to the photopolymerization initiator, a photosensitizer may be used. Specific examples of the photosensitizer employable herein include n-butylamine, tiethylamine, tri-n-butylphosphine, Michler's ketone, and thioxanthone.

As the heat radical polymerization initiator there may be used an organic or inorganic peroxide, an organic azo or diazo compound or the like.

Specific examples of organic peroxides as heat radical polymerization initiator include benzoyl peroxide, halogen benzoyl peroxide, lauroyl peroxide, acetyl peroxide, dibutyl peroxide, cumene hydroxperoxide, and butyl hydroperoxide. Specific examples of inorganic peroxides as heat radical polymerization initiator include hydrogen peroxide, ammonium persulfate, and potassium persulfate. Specific examples of azo compounds as heat radical polymerization initiator include 2,2′-azobis (isobutylonitrile), 2,2′-azobis(propionitrile), and 1,1′-azobis(cyclohexanecarbonitrile). Specific examples of diazo compounds as heat radical polymerization initiator include diazoaminobenzene, and p-nitrobenzenediazonium.

The polymer having a polyether as a main chain is preferably a ring-opening polymerization product of polyfunctional epoxy compound. The ring-opening polymerization of polyfunctional epoxy compound can be carried out by irradiation with ionizing radiation or heating in the presence of a photo-acid generator or heat-acid generator.

Accordingly, a coating solution containing a polyfunctional epoxy compound, a photo-acid generator or heat-acid generator, a light-transmitting particulate material and an inorganic filler is prepared. The coating solution thus prepared is spread over a transparent support, and then irradiated with ionizing radiation or heated to undergo polymerization reaction and curing leading to the formation of an anti-reflection film.

Instead of or in addition to the incorporation of monomer having two or more ethylenically unsaturated groups, a monomer having a crosslinkable functional group may be used to incorporate a crosslinkable functional group in the polymer whereby the reaction of the crosslinkable functional group causes the incorporation of a crosslinked structure in the binder polymer.

Examples of the crosslinkable functional group include isocyanate groups, epoxy groups, aziridine groups, oxazoline groups, aldehyde groups, carbonyl groups, hydrazine groups, carboxyl groups, methylol groups, and active methylene groups. A vinylsulfonic acid, an acid anhydride, a cyano acrylate derivative, a melamine, an etherified methylol, an ester, an urethane or a metal alkoxide such as tetramethoxysilane may be used as a monomer for the incorporation of a crosslinked structure. A functional group which exhibits crosslinkability as a result of decomposition reaction such as blocked isocyanate group may be used. In other words, the crosslinkable functional group to be used in the invention may be not immediately reactive but may be reactive as a result of decomposition reaction.

These binder polymers having a crosslinkable functional group may form a crosslinked structure when heated after being spread.

(Polymer Compound)

The anti-glare layer according to the invention contains a polymer compound. The polymer compound has already formed a polymer before being incorporated in the coating composition. The polymer compound is incorporated mainly for the purpose of adjusting the viscosity of the coating composition concerning the dispersion stability (cohesiveness) of the light-transmitting particulate material or controlling the polarity of the solidified material at the drying step to change the cohesive behavior of the light-transmitting particulate material or eliminate the occurrence of drying unevenness at the drying step.

Examples of the polymer compound according to the invention include (meth)acrylic resins, vinyl-based resins, cellulose-based resins, urethane-based resins, and ether-based resins.

Referring further to the monomer compound to be polymerized to produce (meth)acrylic resins according to the invention, specific examples of acrylic cid esters include methyl acrylate, ethyl acrylate, n-propyl acrylate, isopropyl acrylate, n-butyl acrylate, isobutyl acrylate, sec-butyl acrylate, tert-butyl acrylate, amyl acrylate, hexyl acrylate, 2-ethylhexyl acrylate, octyl acrylate, tert-octyl acrylate, 2-chloroethyl acrylate, 2-bromoethyl acrylate, 4-chlorobutyl acrylate, cyanoethyl acrylate, 2-acetoxyethyl acrylate, dimethylaminoethyl acrylate, benzyl acrylate, methoxybenzyl acrylate, 2-chlorocyclohexyl acrylate, cyclohexyl acrylate, furfuryl acrylate, tetrahydrofurfuryl acrylate, phenyl acrylate, 2-hydroxyethyl acrylate, 5-hydroxybenzyl acrylate, 2,2-dimethyl-3-hydroxypropyl acrylate, 2-methoxyethyl acrylate, 3-methoxybutyl acrylate, 2-ethoxyethyl acrylate, 2-iso-propoxy acrylate, 2-butoxy acrylate, 2-(2-methoxyethoxy)ethyl acrylate, 2-(2-butoxyethoxy)ethyl acrylate, ω-methoxypolyethylene glycol acrylate (number of added mols n=9), 1-bromo-2-methoxyethyl acrylate, and 1,1-dichloro-2-ethoxyethyl acrylate.

Specific examples of methacrylic acid esters include methyl methacrylate, ethyl methacrylate, n-propyl methacrylate, isopropyl methacrylate, n-butyl methacrylate, isobutyl methacrylate, sec-butyl methacrylate, tert-butyl methacrylate, amyl methacrylate, hexyl methacrylate, 2-ethylhexyl methacrylate, cyclohexyl methacrylate, benzyl methacrylate, chlorobenzyl methacrylate, octyl methacrylate, sulfopropyl methacrylate, N-ethyl-N-phenylaminoethyl methacrylate, 2-(3-phenylpropyloxy) ethyl methacrylate, dimethylaminophenoxyethyl methacrylate, furfuryl methacrylate, tetrahydrofurfuryl methacrylate, naphthyl methacrylate, 2-hydroxyethyl methacrylate, 4-hydroxybutyl methacrylate, triethylene glycol monomethacrylate, dipropylelene monomethacrylate, 2-methoxyethyl methacrylate, 3-methoxybutyl methacrylate, 2-acetoxy ethyl methacrylate, 2-acetoactoxyethyl methacrylate, 2-ethoxyethyl methacrylate, 2-iso-propoxyethyl methacrylate, 2-ethoxyethyl methacrylate, 2-(2-methoxyethoxy)ethyl methacrylate, 2-(2-ethoxyethoxy) ethyl methacrylate, 2-(2-butoxyethoxy)ethyl methacrylate, ω-methoxypolyethylene glycol methacrylate (number of added mols n=6), allyl methacrylate, and dimethylaminoethylmethyl chloride methacrylate.

Examples of vinylesters include vinyl acetate, vinyl propionate, vinyl butyrate, vinyl isobutyrate, vinyl caproate, vinyl chloroacetate, vinyl methoxy acetate, vinyl phenyl acetate, vinyl benzoate, and vinyl salicylate.

Examples of olefins include vinyl chloride, vinylidene chloride, isoprene, chloroprene, and butadiene.

Examples of styrenes include styrene, methyl styrene, dimethyl styrene, trimethyl styrene, ethyl styrene, isopropyl styrene, chloromethyl styrene, methoxy styrene, acetoxy styrene, chlorostrene, dichlorostyrene, bromostyrene, trifluoromethylstyrene, and methylester vinylvenzoate.

Examples of crotonic acid esters include butyl crotonate, and hexyl crotonate.

Examples of itaconic acid diesters include dimethyl itaconate, diethyl itaconate, and dibutyl itaconate.

Examples of maleic acid diesters include diethyl maleate, dimethyl maleate, and dibutyl maleate.

Examples of fumaric acid diesters include diethyl fumarate, dimethyl fumarate, and dibutyl fumarate.

Examples of acrylamides include acrylamide, methyl acrylamide, ethyl acrylamide, propyl acrylamide, butyl acrylamide, tert-butyl acrylamide, cyclohexyl acrylamide, benzyl acrylamide, hydroxymethyl acrylamide, methoxyethyl acrylamide, dimethylaminoethyl acrylamide, phenyl acrylamide, dimethyl acrylamide, diethyl acrylamide, and β-cyanoethyl acrylamide.

Examples of methacrylamides include methacrylamide, methyl methacrylamide, ethyl methacrylamide, propyl methacrylamide, butyl methacrylamide, tert-butyl methacrylamide, cyclohexyl methacrylamide, benzyl methacrylamide, hydroxymethyl methacrylamide, methoxyethyl methacrylamide, dimethylaminoethyl methacrylamide, phenyl methacrylamide, dimethyl methacrylamide, diethyl methacrylamide, and β-cyanoethyl methacrylamide.

Allyl compounds such as allyl acetate, allyl caproate, allyl laurate and allyl benzoate may be used as well.

Examples of vinyl ethers include methyl vinyl ether, butyl vinyl ether, hexyl vinyl ether, methoxy ethyl vinyl ether, and dimethylamino ethyl vinyl ether.

Examples of vinyl ketones include methyl vinyl ketone, phenyl vinyl ketone, and methoxy ethyl vinyl ketone.

Examples of vinyl heterocyclic compounds include vinyl pyridine, N-vinylimidazole, N-vinyl oxazolidone, N-vinyl triazole, and N-vinyl pyrrolidone.

Examples of glycidyl esters include glycidyl acrylate, and glycidyl methacrylate.

Examples of unsaturated nitriles include acrylonitrile, and methacrylonitrile.

Examples of polyfunctional monomers include divinyl benzene, methylene bisacrylamide, and ethylene glycol dimethacrylate.

Examples of polyfunctional monomers include divinyl benzene, methylene bisacrylaide, and ethylene glycol dimethacrylate.

Further examples of monomer compounds employable herein include acrylic acid, methacrylic acid, itaconic acid, maleic acid, itaconic acid monoalkyl such as monomethyl itaconate, monoethyl itaconate and monobutyl itaconate, maleic acid monoalkyl such as monomethyl maleate, monoethyl maleate and monobutyl maleate, citraconic acid, styrenesulfonic acid, vinylbenzylsulfonic acid, vinylsulfonic acid, acryloyl oxyalkylsulfonic acid such as acryloyloxymethylsulfonic acid, methacryloyloxyalkylsulfonic acid such as methacryloyloxymethylsulfonic acid, acrylamide alkyl sulfonic acid, 2-acrylamide-2-methylethanesulfonic acid, methacrylamide alkyl sulfonic acid such as 2-methacrylamide-2-methylethanesulfonic acid, and acryloyl oxyalkyl phosphate such as acryloyloxyethyl phosphate. These acids may be used in the form of alkaline metal salt or ammonium salt.

Further examples of monomer compounds employable herein include those disclosed in U.S. Pat. Nos. 3,459,790, 3,438,708, 3,554,987, 4,215,195 and 4,247,673, and JP-A-57-205735.

The polymer compound made of the aforementioned monomer compound may be a polymer compound made of a homopolymer obtained by the polymerization of a single monomer or a copolymer obtained by the polymerization of a plurality of monomers. However, the polymer compound is preferably a copolymer from the standpoint of polymerizability, solubility, etc.

Preferred among these polymer compounds are (meth)acrylic resins such as methyl methacrylate/methyl acrylate copolymer, methyl methacrylate/ethyl acrylate copolymer, methyl methacrylate/butyl acrylate copolymer, methyl methacrylate/butyl methacrylate copolymer, methyl methacrylate/styrene copolymer, methyl methacrylate/methacrylic acid copolymer and methyl polymethacrylate.

Specific examples of polymer compounds include the following compounds.

K1: Poly(methyl methacrylate/methyl acrylate=90/10)

Mw=16,000

K2: Poly(methyl methacrylate/methyl acrylate=90/10)

Mw=54,000

K3: Poly(methyl methacrylate/methyl acrylate=90/10)

Mw=170,000

K4: Poly(methyl methacrylate/methyl acrylate=90/10)

Mw=350,000

K5: Poly(methyl methacrylate/methyl acrylate=90/10)

Mw=680,000

K6: Poly(methyl methacrylate/methyl acrylate=95/5)

Mw=173,000

K7: Poly(methyl methacrylate/methyl acrylate=80/20)

Mw=170,000

K8: Poly(methyl methacrylate/methyl acrylate=60/40)

Mw=172,000

K9: Poly(methyl methacrylate/methyl acrylate=90/10)

Mw=174,000

K10: Poly(methyl methacrylate/butyl acrylate=80/20)

Mw=167,000

K11: Poly(methyl methacrylate/butyl methacrylate=80/20)

Mw=178,000

K12: Poly(methyl methacrylate/styrene=80/20)

Mw=174,000

K13: Poly(methyl methacrylate/methacrylic acid=90/10)

Mw=170,000

K14: Methyl polymethacrylate Mw=124,000

K15: Methyl polymethacrylate Mw=46,000

Particularly preferred among these specific examples are K2, K3, K9 and K10.

The synthesis of these polymers can be carried out by a method as disclosed in JP-A-5-295215, JP-A-5-155907, JP-A-10-87739, JP-A-1-266104, JP-A-1-146910, British Patent 1,211,039, and “Gousei Kobunshi (Synthetic Polymers)”, No. 1, pp. 246-290, No. 3, pp. 1 to 108.

For example, a method may be used which comprises adding a single or two or more monomers containing a polymerization initiator to an aqueous phase containing a small amount of a suspension stabilizer such as hydrophilic polymer, heating the mixture with stirring for several hours to cause polymerization, and then subjecting the resulting polymer to washing, separation and drying.

Alternatively, a method may be used which comprises adding a polymerization initiator dropwise directly to monomers in a system free of aqueous phase while controlling the concentration of the polymerization initiator to cause polymerization at a predetermined temperature for a predetermined period of time, dispensing the polymer by portions, and then evaporating unreacted monomers to obtain a solid material.

The polymerization temperature is from 20° C. to 180° C., preferably from 40° C. to 120° C. The polymerization initiator is preferably added in an amount of from 0.05% to 5% by mass based on the amount of the monomers to be polymerized. Examples of the polymerization initiator employable herein include azobis compounds, peroxides, hydroperoxides, and redox catalysts such as potassium persulfate, t-butyl peroctoate, benzoyl peroxide, isopropyl percarbonate, 2,4-dichlorobenzoyl peroxide, methyl ethyl ketone peroxide, cumene hydroperoxide, dicumyl peroxide and azobisisobutyronitrile.

Examples of aqueous polymers as suspension stabilizer include polyvinyl alcohols, poly(meth)acrylic acids, metal salts thereof, and aqueous modified celluloses.

The weight-average molecular weight of (meth)acrylic resins is preferably 3,000 to 400,000, more preferably 5,000 to 300,000, and further more preferably 5,000 to 200,000. When the weight-average molecular weight is within the above-mentioned range, the viscosity rise effect of coating composition is sufficiently attained, the solution time is short, and insoluble matter is low.

Examples of the polymer compound products of (meth)acrylic resins employable herein include polymethacrylic acid ester-based polymer compounds such as poly(methyl methacrylate/ethyl acrylate) (molecular weight: 101,000), poly(methyl methacrylate/butyl methacrylate) (molecular weight: 75,000), methyl polymethacrylate (molecular weight: 120,000, 15,000, 350,000, 996,000) (produced by SIGMA-ALDRICH Japan K.K.), isobutyl polymethacrylate (molecular weight: 300,000) (produced by KANTO CHEMICAL CO., INC.), ACRYPET MD, VH, MF, V (produced by Mitsubishi Rayon Co., Ltd.), Sumipex LG21, LG, EX, MH (produced by Sumitomo Chemical Co., Ltd.), and Parapet GF, G, GH-S, HR-L, GR (produced by KURARAY CO., LTD.).

It is also preferred that the polymer compound be at least one selected from the group consisting of cellulose-based resins. Such a resin is preferably in the form of ester. Specific examples of esters include cellulose acetate butyrate, cellulose acetate propionate, cellulose diacetate, cellulose triacetate, cellulose propionate, and cellulose nitrate. The weight-average molecular weight of the cellulose-based resin is preferably not smaller than not smaller than 5,000 to not greater than 1,000,000, more preferably not smaller than not smaller than 5,000 to not greater than 600,000, further more preferably not smaller than not smaller than 5,000 to not greater than 400,000 and particularly preferably not smaller than not smaller than 5,000 to not greater than 200,000.

It is further preferred that the polymer compound be at least one selected from the group consisting of vinyl-based resins. Specific examples of these resins include styrene resins, styrene copolymer resins, and vinyl ester-based resins such as vinyl acetate resin, vinyl chloride resin, vinyl fluoride resin and vinyl propionate resin. The weight-average molecular weight of the vinyl-based resin is preferably from not smaller than 5,000 to not greater than 2,000,000, more preferably from not smaller than 5,000 to not greater than 600,000, further more preferably from not smaller than 5,000 to not greater than 400,000, and particularly preferably from not smaller than 5,000 to not greater than 200,000.

As polymer compounds there may be used two or more of the aforementioned resins in combination.

The polymer compound is preferably incorporated in an amount of from 3% to 40% by mass, more preferably from 5% to 30% by mass, even more preferably from 8% to 25% by mass based on the total amount of binders incorporated in the layers containing the polymer compound from the standpoint of development of the effect of raising the viscosity of the coating composition and the maintenance of the strength of the layers containing the polymer compound.

The incorporation of the polymer compound preferably causes the coating composition to show a viscosity rise of 2 mPa·s to 20 mPa·s, more preferably 3 mPa·s to 15 mPa·s, even more preferably 3 mPa·s to 10 mPa·s, particularly 3 mPa·s to 7 mPa·s before being spread over the transparent support. In this manner, the excessive rise of anti-glare properties due to viscosity rise can be inhibited. The above-mentioned range is preferable from the aspect of defects in coat surface conditions, anti-glare properties, and the black tone in vision when the anti-reflection film is applied to the surface of display.

The viscosity of the coating composition containing the polymer compound is preferably from 4 mPa·s to 30 mPa·s, more preferably from 6 mPa·s to 20 mPa·s, and most preferably from 7 mPa·s to 15 mPa·s mainly from the standpoint of control over anti-glare properties and coat surface conditions.

The viscosity can be measured by vibronic viscometer CJV-5000 (A&D Co., LTD) (at 25° C.) or the like.

The viscosity of the coating composition free of polymer compound is preferably from 1 mPa·s to 15 mPa·s, and more preferably from 3 mPa·s to 10 mPa·s.

In the process for the preparation of the anti-glare layer, it is preferred from the standpoint of reduction of process time that the polymer compound be dissolved in a good solvent (e.g., aromatic solvent, ester-based solvent, ketone-based solvent) before being added to the coating composition. The time at which the polymer compound is added to the coating composition is not specifically limited. However, the polymer compound is preferably added as last one of additives to be added from the standpoint of solubility.

<Light-Transmitting Particulate Material>

The anti-glare layer contains a light-transmitting particulate material such as inorganic particulate compound and particulate resin having a particle diameter greater than that of the finely divided inorganic particulate filler described later and an average particle diameter of from 0.5 μm to 10 μm, preferably from 1 μm to 8 μm. The light-transmitting particulate material is used for the purpose of scattering and lowering the external light rays reflected by the surface of display or enhancing the viewing angle (particularly downward viewing angle) of liquid crystal display device to make it difficult for contrast drop, reversal of black and white or hue change to occur even if the viewing angle in the observing direction changes. When the average particle diameter of the light-transmitting particulate material falls within the above defined range, the desired anti-glare effect can be exerted and no sense of surface roughness can occur.

The difference in refractive index between the light-transmitting particulate material and the light-transmitting resin (binder matrix in the anti-glare layer) is preferably from 0.02 to 0.30, particularly from 0.04 to 0.20 from the standpoint of prevention of film whitening and development of sufficient effect of scattering light.

The amount of the light-transmitting particulate material to be added to the light-transmitting resin is properly predetermined from the similar standpoints of view. The content of the light-transmitting particulate material in the layer is preferably from 3% to 40% by mass, particularly from 5% to 25% by mass based on the total solid content in the anti-glare layer.

Referring to the spread of the light-transmitting particulate material, the light-transmitting particulate material is preferably incorporated in the anti-glare layer in an amount of from 10 mg/m² to 10,000 mg/m², more preferably from 50 mg/m² to 4,000 mg/m², most preferably from 100 mg/m² to 1,500 mg/m² as calculated in terms of content in the anti-glare layer thus formed.

Referring to the relationship between the particle diameter of the light-transmitting particulate material and the thickness of the layer containing the light-transmitting particulate material, the average particle diameter of the light-transmitting particulate material is preferably from 20% to 100%, more preferably 30% to 80%, most preferably from 35% to 70% of the thickness of the layer containing the light-transmitting particulate material. When the average particle diameter of the light-transmitting particulate material falls within the above defined range, the resulting anti-reflection film shows an excellent black contrast and density as well as excellent anti-glare properties.

For the measurement of the particle size distribution of particles, Coulter Counter method is used. The distribution thus measured is then converted to distribution of number of particles. The average particle diameter is calculated from the particle distribution thus obtained.

Referring to the light-transmitting particulate material, two or more different light-transmitting particulate materials may be used in combination. In the case where two or more light-transmitting particulate materials are used, the difference in refractive index between the light-transmitting particulate material having the highest refractive index and the light-transmitting particulate material having the lowest refractive index is preferably from not smaller than 0.02 to not greater than 0.10, particularly from not smaller than 0.03 to not greater than 0.07 to effectively attain the control over the refractive index by the mixing of a plurality of kinds of particles. Further, desired anti-glare properties may be provided by a light-transmitting particulate material having a greater particle diameter while other optical properties may be provided by a light-transmitting particulate material having a smaller particle diameter. For example, in the case where an anti-reflection film is stuck to a high-precision display having 133 ppi or more, it is required that an optical defect called “glittering” don't occur. Glittering is attributed to the loss of brightness uniformity caused by the expansion or reduction of pixels due to the unevenness (contributing to anti-glare properties) on the surface of the film. Glittering can be drastically eliminated by the additional use of a light-transmitting particulate material having a smaller particle diameter than the light-transmitting particulate material providing anti-glare properties and a refractive index different from that of the light-transmitting resin.

Specific preferred examples of the aforementioned light-transmitting particulate material include inorganic particulate compounds such as particulate silica, hollow particulate silica, particulate alumina and particulate TiO₂, and particulate resins such as particulate polymethyl methacrylate, particulate crosslinked polymethyl methacrylate, particulate crosslinked methyl methacrylate-styrene copolymer, particulate polystyrene, particulate crosslinked polystyrene, particulate melamine resin, particulate benzoguanamine, particulate polycarbonate and particulate polyvinyl chloride. Particularly preferred among these light-transmitting particulate materials are particulate crosslinked styrene, particulate crosslinked polymethyl methacrylate, particulate crosslinked methyl methacrylate-styrene copolymer, and particulate silica.

The light-transmitting particulate material employable herein may be in spherical form or amorphous form. The light-transmitting particulate material of the invention is preferably monodisperse from the standpoint of controllability of haze and diffusibility and uniformity of coat surface conditions. For example, in the case where a particulate material having a diameter greater than the average particle diameter by 20% or more is defined to be a coarse particulate material, the proportion of the coarse particulate material is preferably 1% or less, more preferably 0.1% or less, even more preferably 0.01% or less of the total number of particles. The particulate material having such a particle diameter distribution can be obtained by properly classifying particles obtained by ordinary synthesis. A particulate material having a better distribution can be obtained by raising the number of classification steps or intensifying the degree of classification.

(Finely Divided Inorganic Filler)

In order to enhance the refractive index of the anti-glare layer, the anti-glare layer preferably contains a finely divided inorganic filler made of an oxide of at least one metal selected from the group consisting of titanium, zirconium, aluminum, indium, zinc, tin and antimony having an average primary particle diameter of 0.2 μm or less, preferably 0.1 μm or less, more preferably 0.06 μm or less in addition to the aforementioned light-transmitting particulate material.

On the contrary, in the anti-glare layer comprising a high refraction light-transmitting particulate material, the refractive index of the binder must be lowered to raise the difference in refractive index from the light-transmitting particulate material. To this end, it is also preferred that a hollow particulate silica be used. The preferred particle diameter of the hollow particulate silica is the same as that of the aforementioned high refraction finely divided inorganic filler.

Specific examples of the finely divided inorganic filler to be incorporated in the anti-glare layer include TiO₂, ZrO₂, Al₂O₃, In₂O₃, ZnO, SnO₂, Sb₂O₃, ITO, and SiO₂. Particularly preferred among these finely divided inorganic fillers are TiO₂ and ZrO₂ from the standpoint of enhancement of refractive index. These inorganic fillers are preferably subjected to silane coupling treatment or titanium coupling treatment on the surface thereof A surface treatment agent having a functional group capable of reacting with the binder seed on the surface of the filler is preferably used.

The amount of these inorganic fillers to be added is preferably from 10% to 90%, more preferably from 20% to 80%, particularly from 30% to 75% based on the total weight of the anti-glare layer.

The finely divided inorganic filler has a particle diameter smaller than the wavelength of light and thus causes no scattering. The dispersion having these fillers dispersed in a binder polymer acts as an optically uniform material.

(Low Refractive Index Layer)

The low refractive index layer of the invention preferably comprises a fluorine-containing compound incorporated therein. It is particularly preferred that a low refractive index layer mainly composed of a fluorine-containing compound be formed. The low refractive index layer mainly composed of a fluorine-containing compound is normally disposed as an outermost layer in the anti-reflection layer and thus acts as a stainproof layer. The term “mainly composed of fluorine-containing compound” as used herein means that the fluorine-containing compound has the highest weight proportion in the constituents of the low refractive index layer. The content of the fluorine-containing compound is preferably 50% by mass or more, more preferably 60% by mass or more based on the total weight of the low refractive index layer.

The fluorine-containing compound to be incorporated in the low refractive index layer is preferably prepared by the crosslinking or polymerization reaction of a fluorine-containing compound having a crosslinking or polymerizable functional group. The crosslinking or polymerizable functional group is preferably an ionizing radiation-curing functional group. The fluorine-containing compound to be incorporated in the low refractive index layer will be further described hereinafter.

<Fluorine-Containing Compound>

The refractive index of the fluorine-containing compound to be incorporated in the low refractive index layer is preferably from 1.35 to 1.50, more preferably from 1.36 to 1.47, even more preferably from 1.38 to 1.45.

Examples of the fluorine-containing compound employable herein include fluorine-containing polymers, fluorine-containing silane compounds, fluorine-containing surface active agents, and fluorine-containing ethers.

Examples of the fluorine-containing polymers employable herein include those synthesized by the crosslinking or polymerization reaction of ethylenically unsaturated monomers containing fluorine atoms. Examples of the ethylenically unsaturated monomers containing fluorine atoms employable herein include fluoroolefins (e.g., fluoroethylene, vinylidene fluoride, tetafluoroethylene, hexafluoropropylene, perfluoro-2,2-dimethyl-1,3-dioxol), fluorinated vinyl ethers, and esters of fluorine-substituted alcohol with acrylic or methacrylic acid.

As the fluorine-containing polymer there may be used also a copolymer comprising a repeating structural unit containing fluorine atom and a repeating structural unit free of fluorine atom.

The aforementioned copolymer may be obtained by the polymerization reaction of an ethylenically unsaturated monomer containing fluorine atom with an ethylenically unsaturated monomer free of fluorine atom.

Examples of the ethylenically unsaturated monomer free of fluorine atom include olefins (e.g., ethylene, propylene, isoprene, vinyl chloride, vinylidene chloride), acrylic acid esters (e.g., methyl acrylate, ethyl acrylate, 2-ethylhexyl acrylate), methacrylic acid esters (e.g., methyl methacrylate, ethyl methacrylate, butyl methacrylate, ethylene glycol dimethacrylate), styrenes and derivatives thereof (e.g., styrene, divinylbenzene, vinyl toluene, α-methylstyrene), vinyl ethers (e.g., methyl vinyl ether), vinyl esters (e.g., vinyl acetate, vinyl propionate, vinyl cinnamate), acrylamides (e.g., N-tert-butylacrylamide, N-cyclohexylacrylamide), and methacrylamides, and acrylonitriles.

Examples of the fluorine-containing silane compounds include silane compounds containing perfluoroalkyl group.

The fluorine-containing surface active agent has some or whole of hydrogen atoms in the hydrocarbon constituting the hydrophobic moiety substituted by fluorine atom. Thus, the hydrophilic moiety of the fluorine-containing surface active agent may be anionic, cationic, nonionic or amphoteric.

The fluorine-containing ether is a compound which is commonly used as a lubricant. As the fluorine-containing ether there may be used a perfluoropolyether or the like.

As the fluorine-containing compound to be incorporated in the low refractive index layer there is particularly preferably used a fluorine-containing polymer having a crosslinked or polymerized structure incorporated therein. The fluorine-containing polymer having a crosslinked or polymerized structure incorporated therein is obtained by the crosslinking or polymerization of a fluorine-containing compound having a crosslinking or polymerizable functional group.

The fluorine-containing compound having a crosslinking or polymerizable functional group can be obtained by introducing a crosslinking or polymerizable functional group into a fluorine-containing compound free of crosslinking or polymerizable functional group as a side chain. The crosslinking or polymerizable functional group is preferably a functional group which undergoes reaction when irradiated with light (preferably ultraviolet rays) or electron beam (EB) or heated to cause the fluorine-containing polymer to have a crosslinked or polymerized structure. Examples of the crosslinking or polymerizable functional group include (meth)acryloyl, isocyanate, epoxy, aziridine, oxazoline, aldehyde, carbonyl, hydrazine, carboxyl, methylol, and active methylene. As the fluorine-containing compound having a crosslinking or polymerizable functional group there may be used any commercially available product.

The fluorine-containing compound to be incorporated in the low refractive index layer preferably contains as a main component a copolymer comprising a repeating unit derived from fluorine-containing vinyl monomer and a repeating unit having (meth)acryloyl group in side chain. The proportion of the component derived from the copolymer is preferably 50% by mass or more, more preferably 70% by mass or more, particularly 90% by mass or more based on the total weight of the outermost layer. The aforementioned copolymer which is preferably incorporated in the low refractive index layer will be described hereinafter.

Examples of the fluorine-containing vinyl monomer include fluoroolefins (e.g., fluoroethylene, vinylidene fluoride, tetrafluoroethylene, hexafluoroethylene, hexafluoroporopylene), partly or fully-fluorinated alkylester derivatives of (meth)acrylic acids (e.g., Biscoat 6FM (trade name, produced by Osaka Organic Chemical Industry Co., Ltd.), M-2020 (trade name, produced by DAIKIN INDUSTRIES, ltd.)), and fully or partly-fluorinated vinyl ethers. Preferred among these fluorine-containing vinyl monomers are perfluoroolefins. Particularly preferred among these fluorine-containing vinyl monomers is hexafluoropropylene from the standpoint of refractive index, solubility, transparency and availability.

The fluorine-containing vinyl monomer is preferably incorporated in such an amount that the fluorine content in the copolymer is from 20% to 60% by mass, more preferably from 25% to 55% by mass, particularly from 30% to 50% by mass.

The aforementioned copolymer has a repeating unit having (meth)acryloyl group. The method for the introduction of (meth)acryloyl group is not specifically limited. Examples of the method for the introduction of (meth)acryloyl group include (i) a method which comprises synthesizing a polymer a nucleophilic group such as hydroxyl group and amino group, and then reacting the polymer with (meth)acrylic acid chloride, (meth) acrylic acid anhydride, mixed acid anhydride comprising (meth)acrylic acid and methanesulfonic acid or the like, (ii) a method which comprises reacting the aforementioned polymer having a nucleophilic group with (meth)acrylic acid in the presence of a catalyst such as sulfuric acid, (iii) a method which comprises reacting the aforementioned polymer having a nucleophilic group with a compound having an isocyanate group such as methacryloyloxy propyl isocyanate and a (meth)acryloyl group in combination, (iv) a method which comprises synthesizing a polymer having an epoxy group, and then reacting the polymer with a (meth)acrylic acid, (v) a method which comprises reacting a polymer having carboxyl group with a compound having an epoxy group such as glycidyl methacrylate and a (meth)acryloyl group in combination, and (vi) a method which comprises polymerizing a vinyl monomer having 3-chloropropionic acid ester moiety, and then subjecting the polymer to dehydrochlorination. In particular, a (meth)acryloyl group is preferably introduced into the polymer having hydroxyl group by the method (i) or (ii).

The repeating unit having (meth)acryloyl group in its side chain preferably accounts for from 5% to 90% by mass, more preferably from 30% to 70% by mass, particularly from 40% to 60% by mass of the aforementioned copolymer.

The aforementioned copolymer may be properly copolymerized with other vinyl monomers besides the aforementioned repeating unit derived from fluorine-containing vinyl monomer and repeating unit having (meth)acryloyl group in its side chain from the standpoint of adhesivity to underlying layer such as transparent support, Tg of polymer (contributing to film hardness), solubility in solvent, transparency, slipperiness, dustproofness, stainproofness, etc. These vinyl monomers may be used in combination of two or more thereof. These vinyl monomers are preferably incorporated in an amount of from 0 to 65 mol-%, more preferably from 0 to 40 mol-%, particularly from 0 to 30 mol-% based on the weight of the copolymer.

The vinyl monomer unit employable herein is not specifically limited. Examples of the vinyl monomer unit employable herein include olefins (e.g., ethylene, propylene, isoprene, vinyl chloride, vinylidene chloride), acrylic acid esters (e.g., methyl acrylate, ethyl acrylate, 2-ethylhexyl acrylate, 2-hydroxyethyl acrylate), methacrylic acid esters (e.g., methyl methacrylate, ethyl methacrylate, butyl methacrylate, 2-hydroxyethyl methacrylate), styrene derivatives (e.g., styrene, p-hydroxymethyl styrene, p-methoxy styrene), vinyl ethers (e.g., methyl vinyl ether, ethyl vinyl ether, cyclohexyl vinyl ether, hydroxyethyl vinyl ether, hydroxy butyl vinyl ether), vinyl esters (e.g., vinyl acetate, vinyl propionate, vinyl cinnamate), unsaturated carboxylic acids (e.g., acrylic acid, methacrylic acid, crotonic acid, maleic acid, itaconic acid), acrylamides (e.g., N,N-dimethyl acrylamide, N-tert-butyl acrylamide, N-cyclohexyl acrylamide), methacrylamides (e.g., N,N-dimethyl methacrylamide), and acrylonitrile derivatives.

A preferred form of the copolymer comprising a repeating unit derived from fluorine-containing vinyl monomer and a repeating unit having (meth)acryloyl group in its side chain to be used in the invention is represented by the following general formula (1).

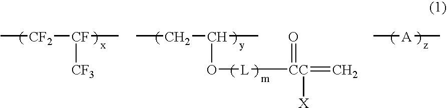

In the general formula (1), L represents a connecting group having from 1 to 10 carbon atoms, preferably from 1 to 6 carbon atoms, particularly from 2 to 4 carbon atoms, which may have a straight-chain, branched or cyclic structure and may have hetero atoms selected from the group consisting of oxygen, nitrogen and sulfur.

Preferred examples of the connecting group include *—(CH₂)₂—O—**, *—(CH₂)₂—NH—**, *—(CH₂)₄—O—**, —(CH₂)₆—O—**, *—(CH₂)₂—O—(CH₂)₂—O—**, *—CONH—(CH₂)₃—O—**, *—CH₂CH(OH)CH₂—O—**, and *—CH₂CH₂OCONH(CH₂)₃—O—** (The symbol * indicates the connecting site on the polymer main chain side. The symbol ** indicates the connecting site on the (meth)acryloyl group side.). The suffix m represents 0 or 1.

In the general formula (1), X represents a hydrogen atom or methyl group. X is preferably a hydrogen atom from the standpoint of curing reaction.

In the general formula (1), A represents a repeating unit derived from an arbitrary vinyl monomer. The repeating unit A is not specifically limited so far as it is a constituent of monomer copolymerizable with hexafluoropropylene. The repeating unit A can be properly selected from the standpoint of adhesivity to underlying layer such as transparent support, Tg of polymer (contributing to film hardness), solubility in solvent, transparency, slipperiness, dustproofness, stainproofness, etc. The repeating unit A may be composed of a single or a plurality of vinyl monomers.

Preferred examples of the repeating unit A include vinyl ethers such as methyl vinyl ether, ethyl vinyl ether, t-butyl vinyl ether, cyclohexyl vinyl ether, isopropyl vinyl ether, hydroxyethyl vinyl ether, hydroxy butyl vinyl ether, glycidyl vinyl ether and allyl vinyl ether, vinyl esters such as vinyl acetate, vinyl propionate and vinyl butyrate, (meth)acrylates such as methyl (meth)acrylate, ethyl (meth)acrylate, hydroxyethyl (meth)acrylate, glycidyl (meth)acrylate, allyl (meth)acrylate and (meth)acryloyloxy propyl trimethoxysilane, styrene derivatives such as styrene and p-hydroxymethylstyrene, unsaturated carboxylic acids such as crotonic acid, maleic acid and itaconinc acid, and derivatives thereof. Preferred among these repeating units are vinyl ether derivatives and vinyl ester derivatives. Particularly preferred among these repeating units are vinyl ether derivatives.

The suffixes x, y and z each represent the molar percentage of the respective constituent. The suffixes x, y and z satisfy the relationships 30≦x≦60, 5≦y≦70 and 0≦z≦65, preferably 35≦x≦55, 30≦y≦60 and 0≦z≦20, particularly 40≦x≦55, 40≦y≦55 and 0≦z≦10.

A particularly preferred form of the aforementioned copolymer is represented by the following general formula (2):

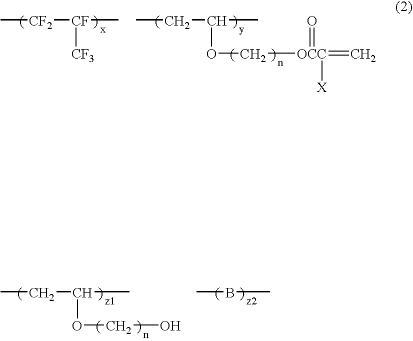

In the general formula (2), X, x and y and their preferred range are as defined in the general formula (1).

The suffix n represents an integer of not smaller than 2 to not greater than 10, preferably not smaller than 2 to not greater than 6, particularly from not smaller than 2 to not greater than 4.

B represents a repeating unit derived from an arbitrary vinyl monomer. The repeating unit B may be composed of a single composition or a plurality of compositions. Examples of the repeating unit B include those listed with reference to A in the general formula (1).

The suffixes z1 and z2 each represent the molar percentage of the respective repeating unit. The suffixes z1 and z2 satisfy the relationships 0≦z1≦65 and 0≦z2≦65, preferably 0≦z1≦30 and 0≦z2≦10, particularly 0≦z1≦10 and 0≦z2≦5.

It is particularly preferred that the copolymer represented by the general formula (2) satisfy the relationships 40≦x≦60, 30≦y≦60 and z2=0.

Specific examples of the copolymer represented by the general formula (1) or (2) include those listed in JP-A-2004-45462, paragraphs [0043]-[0047]. Methods for the synthesis of the copolymer represented by the general formula (1) or (2), too, are described in detail in the above cited patent.

In the invention, the composition to be used in the preparation of the low refractive index layer is preferably in the form of coating compound. The coating compound is prepared by dissolving a fluorine-containing compound as an essential constituent, optionally with various additives and a radical polymerization initiator, in a proper solvent. During this procedure, the solid content concentration is properly predetermined depending on the purpose but is preferably from about 0.01% to 60% by mass, more preferably from about 0.5% to 50% by mass, particularly from about 1% to 20% by mass.

The low refractive index layer may comprise additives such as filler (e.g., inorganic particulate material, organic particulate material), lubricant (e.g., polysiloxane such as dimethyl silicone), organosilane compound and derivative thereof, binder and surface active agent incorporated therein depending on the purpose. It is particularly preferred that a filler (e.g., inorganic particulate material, organic particulate material) or a lubricant (e.g., polysiloxane compound such as dimethyl silicone) be incorporated in the low refractive index layer.

The filler, lubricant and other additives which are preferably incorporated in the low refractive index layer will be described hereinafter.

<Preferred Filler for Low Refraction Layer>

A filler (e.g., inorganic particulate material, organic particulate material) is preferably added to enhance the physical strength (e.g., scratch resistance) of the low refractive index layer. The filler to be incorporated in the low refractive index layer is preferably an inorganic particulate material. Preferred examples of the inorganic particulate material employable herein include silicon dioxide (silica), hollow silica, porous silica, and fluorine-containing particulate material (e.g., magnesium fluoride, calcium fluoride, barium fluoride). Particularly preferred among these inorganic particulate materials are silicon dioxide (silica) and hollow silica.

The weight-average particle diameter of the primary particles of filler is preferably from 1 nm to 150 nm, more preferably from 1 nm to 100 nm, most preferably from 1 nm to 80 nm. The filler is preferably dispersed more finely in the low refractive index layer. The filler is preferably in the form of grain, sphere, cube, spindle, short fiber or ring or in amorphous form. Particularly preferred among these forms are spherical and amorphous. The filler may be either crystalline or noncrystalline.

The filler may be subjected to physical surface treatment such as plasma discharge treatment or chemical surface treatment with a surface active agent, coupling agent or the like to enhance its dispersion stability in the dispersion or coating compound or enhance its affinity or bonding to the constituents of the low refractive index layer. Particularly preferred among these surface treatments is surface treatment with a coupling agent. As such a coupling agent there is preferably used an alkoxy compound (e.g., titanate coupling agent, silane coupling agent). Particularly preferred among these coupling agents is silane coupling agent.

The surface treatment of the filler is preferably effected prior to the preparation of the low refractive index layer. The surface treatment with a coupling agent, if effected, is preferably carried out by adding a coupling agent to the coating compound which is being prepared.

It is preferred that the filler be previously dispersed in a medium (e.g., solvent).

The amount of the filler to be added is preferably from 5% to 70% by mass, more preferably from 10% to 50% by mass, particularly from 20% to 40% by mass based on the total weight of the low refractive index layer from the standpoint of effect of enhancing physical strength (e.g., scratch resistance) and prevention of whitening of the low refractive index layer.

The average particle diameter of the filler is preferably from 20% to 100%, more preferably from 30% to 80%, particularly from 30% to 50% of the thickness of the low refractive index layer.

The particulate silicon dioxide, if incorporated in the low refractive index layer, is particularly preferably a hollow particulate silicon dioxide. The refractive index of the hollow particulate silicon dioxide is preferably from 1.17 to 1.45, more preferably from 1.17 to 1.40, even more preferably from 1.17 to 1.37. The refractive index of the hollow particulate silicon dioxide used herein means the refractive index of the entire particulate material rather than the refractive index of only the shell silica constituting the hollow particulate silicon dioxide. The use of the hollow particulate silicon dioxide makes it possible to reduce the refractive index of the low refractive index layer.

Supposing that the radius of the bore of the particle is a and the radius of the shell of the particle is b, the percent void x is represented by the following numerical formula (1):
x=(4πa³/3)/(4πb³/3)×100 (VII)

The percent void is preferably from 10% to 60%, more preferably from 20% to 60%, most preferably from 30% to 60%.

Two or more fillers are preferably used in combination. Further, particulate materials having different average particle diameters may be used in combination.

<Preferred Lubricant for Low Refractive Index Layer>

A lubricant is preferably added from the standpoint of enhancement of physical properties (e.g., scratch resistance) of the low refractive index layer.

Examples of the lubricant employable herein include fluorine-containing ether compounds (e.g., perfluoropolyether, derivatives thereof), and polysiloxane compounds (e.g., dimethyl polysiloxane, derivatives thereof). Preferred among these lubricants are polysiloxane compounds.

A preferred example of the polysiloxane compounds is a compound containing a plurality of dimethyl silyloxy groups as repeating unit and having substituents at least at the end thereof and in its side chains.

The compound containing dimethyl silyloxy groups as repeating unit may contain structural units (substituents) other than dimethyl silyloxy group. These substituents may be the same or different. A plurality of these substituents are preferably present.

Preferred examples of these substituents include those containing (meth)acryloyl groups, vinyl groups, aryl groups, cinnamoyl groups, epoxy groups, oxetanyl groups, hydroxyl groups, fluoroalkyl groups, polyoxyalkylene groups, carboxyl groups, and amino groups.

The molecular weight of the lubricant is not specifically limited but is preferably 100,000 or less, particularly 50,000 or less, most preferably from 3,000 to 30,000. The content of silicon atom in the siloxane compound is not specifically limited but is preferably 5% by mass or more, particularly from 10% to 60% by mass, most preferably from 15% to 50% by mass.

Particularly preferred examples of the lubricant include polysiloxane compounds having a crosslinking or polymerizable functional group represented by the following general formula (A) and derivatives thereof (e.g., crosslinking or polymerization products of polysiloxane compound represented by the general formula (A), reaction products of polysiloxane compound represented by the general formula (A) with compound having a crosslinking or polymerizable functional group other than polysiloxane compound).

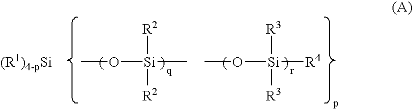

In the general formula (A), R¹ to R⁴ each independently represent a C₁-C₂₀ substituent, with the proviso that a plurality of these groups, if any, may be the same or different and at least one of R¹, R³ and R⁴ represents a crosslinking or polymerizable functional group.

The suffix p represents an integer that satisfies the relationship 1≦p≦4. The suffix q represents an integer that satisfies the relationship 10≦q≦500. The suffix r represents an integer that satisfies the relationship 0≦r≦500. The polysiloxane moiety surrounded by the parenthesis { } may be a random copolymer or block copolymer.

The low refractive index layer to be used in the invention preferably contains at least any of polysiloxane compound having a crosslinking or polymerizable functional group represented by the general formula (A) and derivatives thereof and cured materials containing fluorine-containing compound.

The content of any of the polysiloxane compound and derivatives thereof is preferably from 0.1% to 30% by mass, more preferably from 0.5% to 15% by mass, particularly from 1% to 10% by mass based on the weight of the fluorine-containing compound.

The crosslinking or polymerizable functional group which is preferably incorporated in the polysiloxane compound and derivatives thereof may be a functional group that can undergo crosslinking or polymerization reaction with other constituents of the outermost layer (e.g., fluorine-containing compound, binder) to form a bond. Examples of the functional group employable herein include groups having active hydrogen atom (e.g., hydroxyl group, carboxyl group, amino group, carbamoyl group, mercapto group, β-ketoester group, hydrosilyl group, silanol group), cationically polymerizable groups (e.g., epoxy group, oxetanyl group, oxazolyl group, vinyl group, vinyloxy group), groups having an unsaturated double bond capable of undergoing crosslinking or polymerization with radical seed (e.g., (meth)acryloyl group, allyl group), hydrolyzable silyl groups (e.g., alkoxysilyl group, acyloxysilyl group), acid anhydrides, isocyanate groups, and groups substitutable by nuecleophilic agent (e.g., active halogen atom, sulfonic acid ester).

These crosslinking or polymerizable functional groups may be properly selected according to the constitutents of the low refractive index layer. An ionizing radiation-curing functional group is preferably used.

The crosslinking or polymerizable functional group in the general formula (A) preferably undergoes crosslinking or polymerization reaction with the crosslinking or polymerizable functional group in the fluorine-containing compound. Particularly preferred examples of the functional group include cationic ring-opening polymerization-reactive groups (particularly epoxy group, oxetanyl group, etc.), and radical polymerization-reactive groups (particularly (meth) acryloyl group).

The substituent represented by R² in the general formula (A) is a C₁-C₂₀ substituted or unsubstituted organic group. Preferred examples of the C₁-C₂₀ substituted or unsubstituted organic group include C₁-C₁₀ alkyl groups (e.g., methyl group, ethyl group, hexyl group), fluorinated alkyl groups (e.g., trifluoromethyl group, pentafluoroethyl group), and C₆-C₂₀ aryl groups (e.g., phenyl group, naphthyl group). More desirable among these organic groups are C₁-C₅ alkyl groups, fluorinated alkyl groups, and phenyl groups. Particularly preferred among these organic groups is methyl group. These organic groups may be further substituted by these organic groups.

In the case where R¹, R³ and R⁴ in the general formula (A) each are not a crosslinking or polymerizable functional group, they may each be the aforementioned organic group.

The suffix x represents an integer that satisfies the relationship 1≦p≦4. The suffix q represents an integer that satisfies the relationship 10≦q≦500, preferably from 50≦q≦400, particularly from 100≦q≦300. The suffix r represents an integer that satisfies the relationship 0≦r≦500, preferably from 0≦r≦q, particularly from 0≦q≦0.5q.

Referring to the polysiloxane structure of the compound represented by the general formula (A), the repeating unit (—OSi(R²)₂—) may be a homopolymer composed of a single substituent (R²) or a random copolymer or block copolymer composed of repeating units having different substituents in combination.

The weight-average molecular weight of the compound represented by the general formula (A) is preferably from 10³ to 10⁶, more preferably from 5×10³ to 5×10⁵, particularly from 10⁴ to 10⁵.

As the polysiloxane compound represented by the general formula (A) there may be used a commercially available product such as KF-100T, X-22-169AS, KF-102, X-22-3701IE, X-22-164B, X-22-164C, X-22-5002, X-22-173B, X-22-174D, X-22-167B, X-22-161AS, X-22-174DX, X-22-2426, X-22-170DX, X-22-176D, X-22-1821 (produced by Shin-Etsu Chemical Co., Ltd.), AK-5, AK-30, AK-32 (produced by TOAGOSEI CO., LTD.), and Silaplane FM-0275, FM-0721, FM-0725, FM-7725, DMS-U22, RMS-033, RMS-083, UMS-182 (produced by CHISSO CORPORATION). Alternatively, the polysiloxane compound represented by the general formula (A) can be prepared by introducing crosslinking or polymerizable functional groups into the hydroxyl group, amino group, mercapto group, etc. contained in commercially available polysiloxane compounds.

Specific preferred examples of the polysiloxane compound represented by the general formula (A) include those listed in JP-A-2003-329804, paragraphs [0041]-[0045]. However, the invention is not limited to these examples.

The added amount of at least any of the polysiloxane compound represented by the general formula (A) and derivatives thereof is preferably from 0.05% to 30% by mass, more preferably from 0.1% to 20% by mass, even more preferably from 0.5% to 15% by mass, particularly from 1% to 10% by mass based on the total solid content of the outermost layer.

<Low Refractive Index Layer and Method for the Formation Thereof>

The low refractive index layer is preferably prepared by spreading a coating compound prepared by dissolving or dispersing the aforementioned fluorine-containing compound, optionally with the aforementioned filler and at least any of the aforementioned polysiloxane compound and derivatives thereof, in a solvent.

Preferred examples of the solvent employable herein include ketones (e.g., acetone, methyl ethyl ketone, methyl isobutyl ketone, cyclohexanone), esters (e.g., ethyl acetate, butyl acetate), ethers (e.g., tetrahydrofurane, 1,4-dioxane), alcohols (e.g., methanol, ethanol, isopropyl alcohol, butanol, ethylene glycol), aromatic hydrocarbons (e.g., toluene, xylene), and water.

Particularly preferred among these solvents are ketones, aromatic hydrocarbons, and esters. Most desirable among these solvents are ketones. Particularly preferred among these ketones are methyl ethyl ketone, methyl isobutyl ketone, and cyclohexanone. The content of the ketone-based solvents in all the solvents contained in the coating compound is preferably 10% by mass or more, more preferably 30% by mass or more, even more preferably 60% by mass or more.

Two or more solvents may be used in combination.

So far as the fluorine-containing compound contains a crosslinking or polymerizable functional group, the low refractive index layer is preferably prepared by the crosslinking or polymerization reaction of the fluorine-containing compound at the same time or after the spreading of the low refractive index layer coating compound.

In the case where the fluorine-containing compound has a radical-crosslinking or polymerizable functional group, the fluorine-containing compound preferably undergoes crosslinking or polymerization reaction in the presence of a radical polymerization initiator, particularly photoradical polymerization initiator. In the case where the fluorine-containing compound has a cationically crosslinking or polymerizable functional group, the fluorine-containing compound preferably undergoes crosslinking or polymerization reaction in the presence of a cationic polymerization initiator, particularly photocationic polymerization initiator.

As the radical polymerization initiator there is preferably used a compound which generates radical when acted upon by heat or light. In particular, a photoradical polymerization initiator is preferred.

As the compound which generates radical when acted upon by heat there may be used an organic or inorganic peroxide, organic azo or diazo compound or the like.

Specific examples of these organic peroxides include benzoyl peroxide, halogen benzoyl peroxide, lauroyl peroxide, acetyl peroxide, dibutyl peroxide, cumene hydroperoxide, and butyl hydroperoxide. Specific examples of these inorganic peroxides include hydrogen peroxide, ammonium persulfate, and potassium persulfate. Specific examples of these azo compounds include 2-azo-bis-isobutyronitrile, 2-azo-bis-propionitrile and 2-azo-bis-cyclohexane dinitrile. Specific examples of these diazo compounds include diazoaminobenzene, and p-nitrobenzene diazonium.

The case where the compound which initiates radical polymerization when acted upon by light, if used, may be cured by irradiation with light such as ultraviolet ray according to the kind of the compound used to prepare a low refractive index layer.

Examples of the photoradical polymerization initiator employable herein include acetophenones, benzoins, benzophenones, phosphine oxides, ketals, anthraquinones, thioxanthones, azo compounds, peroxides, 2,3-dialkyldione compounds, disulfide compounds, fluoroamine compounds, and aromatic sulfoniums. Examples of these acetophenones include 2,2-diethoxy acetophenone, p-dimethyl acetophenone, 1-hydroxy dimethyl phenyl ketone, 1-hydroxycyclohexyl phenyl ketone, 2-methyl-4-methylthio-2-morpholino propiophenone, and 2-enzyl-2-dimethylamino-1-(4-morpholinophenyl)-butanone. Examples of these benzoins include benzoinbenzenesulfonic acid ester, benzointoluenesulfonic acid ester, benzoin methyl ether, benzoin ethyl ether, and benzoin isopropyl ether. Examples of these benzophenones include benzophenone, 2,4-dichloropbenzophenone, 4,4-dichlorobenzophenone, and p-chlorobenzophenone. Examples of these phosphine oxides include 2,4,6-trimethylbenzoyl diphenyl phosphine oxide.

A photocleavable photoradical polymerization initiator is particularly preferred. For the details of photocleavable photoradical polymerization initiators, reference can be made to Kazuhiro Takausu, “Saishin UV Koka Gijutsu (Modern UV-curing Technique)”, TECHNICAL INFORMATION INSTITUTION CO., LTD., page 159, 1991.

Commercially available photoradical polymerization initiators, too, may be preferably used. Examples of these commercially available photoradical polymerization initiators include initiators listed with reference to the anti-glare layer.

The photopolymerization initiator is preferably used in an amount of from 0.1 to 15 parts by mass, more preferably from 1 to 10 parts by mass based on 100 parts by mass of the fluorine-containing compound. These photopolymerization initiators may be preferably used in combination with a photosensitizer. Examples of the photosensitizer employable herein include n-butylamine, triethylamine, tri-n-butylphosphine, Michler's ketone, and thioxanthone.

A binder is preferably added from the standpoint of enhancement of physical strength (e.g., scratch resistance) of the low refractive index layer and adhesivity of the low refractive index layer to the layer adjacent to the outermost layer.

In the case where the fluorine-containing compound is a compound having a crosslinking or polymerizable functional group, the binder is preferably one having a functional group that undergoes crosslinking or polymerization with the fluorine-containing compound.

In particular, in the case where the fluorine-containing compound is one having a photo-crosslinking or photopolymerizable functional group, the binder is preferably a polyfunctional monomer having a photo-crosslinking or photopolymerizable functional group. Specific examples of the photopolymerizable polyfunctional monomer having a photopolymerizable functional group include those listed with reference to the after-mentioned antistatic layer. Two or more polyfunctional monomers may be used in combination.

The fluorine-containing compound to be incorporated in the low refractive index layer of the invention is preferably a fluorine-containing compound having a crosslinking or polymerizable functional group. As the compound to be used in combination with the fluorine-containing compound there may be used a polysiloxane compound represented by the general formula (A) or derivative thereof, a binder that undergoes crosslinking or polymerization with a fluorine-containing compound having the crosslinking or polymerizable functional group or the like. A plurality of compounds to be used in combination with the fluorine-containing compound may be used in combination.

The low refractive index layer is preferably prepared by spreading a coating compound having a fluorine-containing compound and other constituents of outermost layer dissolved or dispersed therein, accompanied by or followed by the crosslinking or polymerization reaction thereof involving irradiation with light or electron beam or heating.

In the case where irradiation with ultraviolet rays is effected, ultraviolet rays emitted by a light source such as ultrahigh pressure mercury vapor lamp, high pressure mercury vapor lamp, carbon arc, xenon arc, metal halide lamp, etc. may be used.

The preparation of the low refractive index layer is preferably effected in an atmosphere having an oxygen concentration of 4 vol-% or less if the outermost layer is formed by the crosslinking or polymerization reaction of an ionizing radiation-curing compound.

By preparing the low refractive index layer in an atmosphere having an oxygen concentration of 4 vol-% or less, the physical strength (e.g., scratch resistance), chemical resistance and weathering resistance of the low refractive index layer and the adhesivity of the outermost layer to the adjacent layer can be enhanced.

The crosslinking or polymerization reaction of the ionizing radiation-curing compound is preferably effected in an atmosphere having an oxygen concentration of 3 vol-% or less, more preferably 2 vol-% or less, particularly 1 vol-% or less, most preferably 0.5 vol-% or less.

The reduction of the oxygen concentration in the atmosphere to 4 vol-% or less is preferably carried out by replacing the atmosphere (nitrogen concentration: about 79 vol-%; oxygen concentration: about 21 vol-%) by other gases, particularly nitrogen (nitrogen purge).

The thickness of the low refractive index layer is preferably from 30 nm to 200 nm, more preferably from 50 nm to 150 nm, particularly from 60 nm to 120 nm. The thickness of the low refractive index, if used as a stainproof layer, is preferably from 3 nm to 50 nm, more preferably from 5 nm to 35 nm, particularly from 7 nm to 25 nm.

The low refractive index layer preferably has a surface dynamic friction coefficient of 0.25 or less, more preferably 0.17 or less, particularly 0.15 or less to enhance the physical strength of the anti-reflection film. The term “dynamic friction coefficient” as used herein is meant to indicate the dynamic friction coefficient of the surface of the low refractive index layer with respect to a stainless steel sphere having a diameter of 5 mm developed when the stainless steel sphere is moved along the surface of the low refractive index layer at a speed of 60 cm/min under a load of 0.98 N.

In order to enhance the stainproofness of the anti-reflection film, the contact angle of the low refractive index layer with respect to water is preferably 90° or more, more preferably 95° or more, particularly 100° or more.

It is preferred that the contact angle of the low refractive index layer with respect to water undergo no change, preferably a change of 10° or less, particularly 5° or less between from and after saponification.

The haze of the low refractive index layer is preferably as small as possible, more preferably 3% or less, even more preferably 2% or less, particularly 1% or less.

The strength of the low refractive index layer is preferably H or more, more preferably 2H or more, most preferably 3H or more as determined by pencil hardness test according to JIS K-5400. The abrasion of the low refractive index layer from before test to after test is preferably as small as possible as determined by Taber test according to JIS K-5400.

The low refractive index layer may comprise a surface active agent, an antistatic agent, a coupling agent, a thickening agent, a coloring inhibitor, a coloring agent (pigment, dye), an anti-foaming agent, leveling agent, a fire retardant, an ultraviolet absorber, an infrared absorber, an adhesivity-providing agent, a polymerization inhibitor, an oxidation inhibitor, a surface modifier, etc. incorporated therein besides the aforementioned components (e.g., fluorine-containing compound, polymerization initiator, photosensitizer, filler, lubricant, binder).

The refractive index of the low refractive index layer is preferably from 1.20 to 1.55, more preferably from 1.30 to 1.50, even more preferably from 1.35 to 1.48, particularly from 1.37 to 1.45.

The low refractive index layer preferably comprises a compound selected from the group consisting of organosilane compounds represented by the general formula (a) described later and derivatives thereof (hydrolyzates and crosslinked silicon compounds produced by the condensation thereof) incorporated therein.

(Anti-Static Layer)

The anti-glare anti-reflection film of the invention preferably comprises an antistatic layer to prevent the attachment of dust to the surface thereof. The dustproofness of the anti-reflection film can be developed by reducing the surface resistivity of the surface thereof. The surface resistivity of the anti-reflection film is preferably 1×10¹³ Ω/sq. or less, more preferably 1×10¹² Ω/sq. or less, even more preferably 1×10¹⁰ Ω/sq. or less.

The antistatic layer is preferably provided between the anti-glare layer and the low refractive index layer or between the transparent support and the anti-glare layer.

In the case where the antistatic layer is formed by spreading, the antistatic layer is preferably formed by a binder comprising an electrically-conductive material (e.g., electronically-conductive particulate material, ionically-conductive organic compound) incorporated therein. In particular, an electronically-conductive material is preferably used because it is little subject to effect of environmental change and thus shows stable electrical conductivity and hence good electrical properties even under low humidity conditions.

Preferred examples of the electrically-conductive material to be incorporated in the antistatic layer include tin oxide, tin oxide doped with antimony (ATO), indium oxide, indium oxide doped with tin (ITO), lead oxide, and zinc oxide doped with aluminum.

The weight-average particle diameter of the primary particles of electrically-conductive material is preferably from 1 nm to 200 nm, more preferably from 1 nm to 100 nm. The specific surface area of the electrically-conductive material is preferably from 10 m²/g to 400 m²/g, more preferably from 20 m²/g to 200 m²/g.

The electrically-conductive material is preferably dispersed in a dispersion medium in the presence of a dispersant. For dispersion, a dispersant containing an anionic group having an acidic proton such as carboxyl group, sulfonic acid group (sulfo group), phosphoric acid group (phosphono group) and sulfonamide group is preferably used. Examples of the dispersant having an anionic polar group include Phosphanol (PE-510, PE-610, LB-400, EC-6103, RE-410, produced by TOHO Chemical Industry Co., LTD.), and Disperbyk (-110, -111, -116, -140, -161, -162, -163, -164, -164, -170, -171, produced by BYK-Chemie Japan Ltd.). The dispersant preferably further contains a crosslinking or polymerizable functional group.

As the dispersion medium there is preferably used a liquid having a boiling point of from 60° C. to 170° C.

Preferred among these liquid dispersion media are toluene, xylene, methyl ethyl ketone, methyl isobutyl ketone, cyclohexanone, butanol, propanol, and cellosolves (e.g., propylene glycol monomethyl ether). Particularly preferred among these liquid dispersion media are methyl ethyl ketone, methyl isobutyl ketone, and cyclohexanone.

The electrically-conductive material is preferably dispersed using a media type dispersion machine such as sand grinder mill (e.g., bead mill with pin), dinomill, high speed impellor mill, Eiger mill, pebble mill, roller mill, attritor, colloid mill and pain shaker.

The electrically-conductive material is preferably divided as finely as possible in the dispersion medium. The weight-average particle diameter of the electrically-conductive material is preferably from 1 nm to 200 nm.

As the binder precursor to be incorporated in the antistatic layer of the invention there is preferably used an ionizing radiation-curing polyfunctional monomer or polyfunctional oligomer such as (meth)acryloyl group, vinyl group, styryl group and allyl group, etc.

The formation of the antistatic layer is preferably formed by the crosslinking or polymerization reaction of an ionizing radiation-curing compound in an atmosphere having an oxygen concentration of 4 vol-% or less.

The thickness of the antistatic layer can be properly designed depending on the purpose. In the case where the antistatic layer is formed in preference to transparency, the thickness of the antistatic layer is preferably 1 μm or less, more preferably 500 nm or less, even more preferably 200 nm or less, particularly 150 nm or less.

In the case where the antistatic layer is subjected to hard coat treatment to act also as a hard coat layer, the thickness of the antistatic layer is preferably from 1 μm to 10 μm, more preferably from 2 μm to 7 μm, particularly from 3 μm to 5 μm.

The antistatic layer may comprise a resin, a surface active agent, a coupling agent, a thickening agent, a coloration inhibitor, a coloring agent (pigment, dye), an anti-foaming agent, a leveling agent, a fire retardant, an ultraviolet absorber, an infrared absorber, an adhesivity-providing agent, a polymerization initiator, an oxidation inhibitor, a surface modifying agent, etc. incorporated therein besides the aforementioned components (e.g., electrically-conductive material, polymerization initiator, photosensitizer, binder).

(Other Coat Layers)

It is also preferred that the anti-glare anti-reflection film of the invention comprise a hard coat layer provided interposed between the transparent support and the outermost layer to have physical strength.

The hard coat layer is preferably formed by the crosslinking reaction or polymerization reaction of an ionizing radiation-curing compound, e.g., by spreading a coating compound containing an ionizing radiation-curing polyfunctional monomer or polyfunctional oligomer over a transparent support, and then allowing the polyfunctional monomer or polyfunctional oligomer to undergo crosslinking reaction or polymerization reaction.

Specific examples of the potopolymerizable polyfunctional monomer having a photopolymerizable functional group include those listed with reference to the anti-glare layer. The polymerization of the potopolymerizable polyfunctional monomer is preferably effected in the presence of a photopolymerization initiator or photosensitizer. The photopolymerization initiator is preferably carried out by irradiation of the hard coat layer spread and dried with ultraviolet rays.

The thickness of the hard coat layer is preferably from 1 μm to 10 μm, more preferably from 2 μm to 7 μm, particularly from 3 μm to 5 μm.

The strength of the hard coat layer is preferably H or more, more preferably 2H or more, most preferably 3H or more as determined by pencil hardness test according to JIS K-5400. The abrasion of the hard coat layer from before test to after test is preferably as small as possible as determined by Taber test according to JIS K-5400.

The hard coat layer may comprise a resin, a surface active agent, an antistatic agent, a silane coupling agent, a thickening agent, a coloration inhibitor, a coloring agent (pigment, dye), an anti-foaming agent, a leveling agent, a fire retardant, an ultraviolet absorber, an adhesivity-providing agent, a polymerization initiator, an oxidation inhibitor, a surface modifying agent, etc. incorporated therein. The hard coat layer may also comprise an inorganic particulate material having an average primary particle diameter of from 1 nm to 200 nm described later incorporated therein for the purpose of raising the hardness of the hard coat layer, inhibiting the hardening shrinkage and controlling the refractive index.

The hard coat layer may further comprise the aforementioned particulate material having an average particle diameter of from 0.2 μm to 10 μm incorporated therein for the purpose of providing anti-glare properties and effect of enhancing the viewing angle of liquid crystal display device to form an anti-glare or scattering hard coat layer.

(Transparent Support)

As the transparent support there is preferably used a plastic film. Examples of the material of plastic sheet include cellulose esters (e.g., triacetyl cellulose, diacetyl cellulose, propionyl cellulose, butyryl cellulose, acetyl propionyl cellulose, nitrocellulose), polyamides, polycarbonates, polyesters (e.g., polyethylene terephthalate, polyethylene naphthalate, poly-1,4-cyclohexane dimethylene terephthalate, polyethylene-1,2-diphenoxyethane-4,4′-dicarboxylate, polybutylene terephthalate), polystyrenes (e.g., syndiotactic polystyrene), polyolefins (e.g., polypropylene, polyethylene, polymethyl pentene), polysulfones, polyethersulfones, polyallylates, polyetherimides, polymethyl methacrylates, and polyetherketones. Preferred among these materials are triacetyl cellulose, polycarbonates, polyethylene terephthalates and polyethylene naphthalates. In particular, in the case where the anti-reflection film is used in liquid crystal display device, triacetyl cellulose is preferably used.

In the case where the transparent support is a triacetyl cellulose film, a triacetyl cellulose film prepared by subjecting a triacetyl cellulose dope prepared by dissolving a triacetyl cellulose in a solvent to any casting method such as single-layer casting method and multi-layer casting method is preferably used.

In particular, a triacetyl cellulose film prepared from a triacetyl cellulose dope prepared by dissolving a triacetyl cellulose in a solvent substantially free of dichloromethane by a low temperature or high temperature dissolution method is preferred from the standpoint of environmental protection.

The triacetyl cellulose film which is preferably used in the invention is exemplified in Japan Institute of Invention and Innovation's Kokai Giho No. 2001-1745.

The thickness of the aforementioned transparent support is not specifically limited but is preferably from 1 μm to 300 μm, preferably from 30 μm to 150 μm, particularly from 40 μm to 120 μm, most preferably from 40 μm to 100 μm.

The light transmittance of the transparent support is preferably 80% or more, more preferably 86% or more.

The haze of the transparent support is preferably as low as possible, more preferably 2.0% or less, even more preferably 1.0% or less.

The refractive index of the transparent support is preferably from 1.40 to 1.70.

The transparent support may comprise an infrared absorber or ultraviolet absorber incorporated therein. The added amount of the infrared absorber is preferably from 0.01% to 20% by mass, more preferably from 0.05% to 10% by mass based on the weight of the transparent support.

The transparent support may further comprise an inactive inorganic particulate compound incorporated therein as a lubricant. Examples of the inorganic compound employable herein include SiO₂, TiO₂, BaSO₄, CaCO₃, talc, and kaolin.

The transparent support may be subjected to surface treatment. Examples of the surface treatment include chemical treatment, mechanical treatment, corona discharge treatment, flame treatment, ultraviolet irradiation, high frequency treatment, glow discharge treatment, active plasma treatment, laser treatment, mixed acid treatment, and ozone oxidation. Preferred among these surface treatments are glow discharge treatment, ultraviolet irradiation, corona discharge treatment and flame treatment. Particularly preferred among these surface treatments are glow discharge treatment and corona discharge treatment.

(Organosilane Compound)

The organosilane compound which can be particularly preferably incorporated in the various layers in the anti-glare anti-reflection film according to the invention will be described hereinafter.

At least one compound selected from the group consisting of organosilane compounds and derivatives thereof is preferably incorporated in any layer on the transparent support from the standpoint of enhancement of physical strength (e.g., scratch resistance) of the layer and the adhesivity of the layer to the layer adjacent to the aforementioned layer.

As the organosilane compounds and derivatives thereof there may be used compounds represented by the following general formula (a) and derivatives thereof. Preferred are organosilane compounds containing hydroxyl group, mercapto group, carboxyl group, epoxy group, alkyl group, alkoxysilyl group, acyloxy group and acylamino group. Particularly preferred are organosilane compounds containing epoxy group, polymerizable acyloxy group (e.g., (meth)acryloyl) polymerizable acylamino group (e.g., acrylamino, methacrylamino) and alkyl group.
(R¹⁰)_{S}—Si(Z)_{4-S} (a)

In the general formula (a), R¹⁰ represents a substituted or unsubstituted alkyl or aryl group. The alkyl group preferably has from 1 to 30, more preferably from 1 to 16, particularly from 1 to 6 carbon atoms. Specific examples of the alkyl group include methyl, ethyl, propyl, isopropyl, hexyl, decyl, and hexadecyl. Examples of the aryl group include phenyl, and naphthyl. Preferred among these alkyl groups is phenyl.

Z represents a hydroxyl group or hydrolyzable group. As Z, alkoxy group (alkoxy group having from 1 to 5 carbon atoms such as methoxy and ethoxy), halogen atom (e.g., chlorine, bromine, iodine) or group represented by R²COO (in which R² is preferably a hydrogen atom or C₁-C₆ alkyl group such as CH₃COO and C₂H₅COO), etc are exemplified. Preferred among these groups are alkoxy groups. Particularly preferred among these alkoxy groups are methoxy and ethoxy.

The suffix s represents an integer of from 1 to 3, preferably 1 or 2.

Each of the plurality of R¹⁰ 's and the plurality of Z's, if any, may be the same or different.

The substituents on R¹⁰ are not specifically limited. Examples of these substituents include halogen atoms (e.g., fluorine, chlorine, bromine), hydroxyl groups, mercapto groups, carboxyl groups, epoxy groups, alkyl groups (e.g., methyl, ethyl, i-propyl, propyl, t-butyl), cycloalkyl group, aryl groups (e.g., phenyl, naphthyl), aromatic heterocyclic groups (e.g., furyl, pyrazolyl, pyridyl), alkoxy groups (e.g., methoxy, ethoxy, i-propoxy, hexyloxy), aryloxy groups (e.g., phenoxy), alkylthio groups (e.g., methylthio, ethylthio), arylthio groups (e.g., phenyltlio), alkenyl groups (e.g., vinyl, 1-propenyl), acyloxy groups (e.g., acetoxy, acryloyloxy, methacryloyloxy), alkoxycarbonyl groups (e.g., methoxycarbonyl, ethoxycarbonyl), aryloxycarbonyl groups (e.g., phenoxycarbonyl), carbamoyl groups (e.g., carbamoyl, N-methylcarbamoyl, N,N-dimethylcarbamoyl, N-methyl-N-octylcarbamoyl), and acylamino groups (e.g., acetylamino, benzoylamino, acrylamino, methacryl amino). These substituents may be further substituted.

Preferred organosilane compounds are organosilane compounds represented by the following general formula (b).

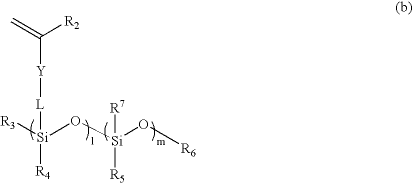

In the general formula (b), R₂ represents a hydrogen atom, methyl group, methoxy group, alkoxycarbonyl group, cyano group, fluorine atom or chlorine atom. Examples of the alkoxycarbonyl group include methoxycarbonyl group, and ethoxycarbonyl group. Preferred among these groups are hydrogen atom, methyl group, methoxy group, methoxycarbonyl group, cyano group, fluorine atom, and chlorine atom. More desirable among these groups are hydrogen atom, methyl group, methoxycarbonyl group, fluorine atom, and chlorine atom. Particularly preferred among these groups are hydrogen atom and methyl group.

Y represents a single bond or *—COO—**, *—CONH—** or *—O—**, preferably single bond, *—COO—** or *—CONH—**, more preferably single bond or *—COO—**, particularly *—COO—** in which * represents the position at which the group is connected to ═C(R₂)— and ** represents the position at which the group is connected to L.

L represents a divalent connecting chain. Specific examples of the divalent connecting chain include substituted or unsubstituted alkylene group, substituted or unsubstituted arylene group, substituted or unsubstituted alkylene group having a connecting group thereinside (e.g., ether, ester, amide), and substituted or unsubstituted arylene group having a connecting group thereinside. Preferred among these groups are substituted or unsubstituted alkylene group, substituted or unsubstituted arylene group, and alkylene group having a connecting group thereinside. More desirable among these groups are unsubstituted alkylene group, unsubstituted arylene group and alkylene group having ether or ester connecting group thereinside. Particularly preferred among these groups are unsubstituted alkylene group and alkylene group having ether or ester connecting group thereinside. Examples of the substituents on these groups include halogen, hydroxyl group, mercapto group, carboxyl group, epoxy group, alkyl group, and aryl group atoms. These substituents may be further substituted.

The suffix l represents a number satisfying the equation l=100−m. The suffix m represents a number of from 0 to 50. The suffix m is more preferably from 0 to 40, particularly from 0 to 30.

R₃ to R₅ each represents a monovalent group, and each preferably represents a halogen atom, hydroxyl group or unsubstituted alkoxy or alkyl group. R₃ to R₅ each are more preferably a chlorine atom, hydroxyl group or C₁-C₆ alkoxy group, even more preferably a hydroxyl group or C₁-C₃ alkoxy group, particularly a hydroxyl group or methoxy group.

R₆ represents a hydrogen atom or alkyl group. The alkyl group is preferably a methyl or ethyl group. R₆ is particularly preferably a hydrogen atom or methyl group.

R₇ represents a substituted or unsubstituted alkyl or aryl group. The alkyl group is preferably a C₁-C₃₀ alkyl group, more preferably C₁-C₁₆ alkyl group, particularly C₁-C₆ alkyl group. Specific examples of the alkyl group include methyl, ethyl, propyl, isopropyl, hexyl, decyl, and hexadecyl. Examples of the aryl group include phenyl, and naphthyl. Preferred among these aryl groups is phenyl.

Each of the plurality of R₄ and, the plurality of R₅ and the plurality of R₇, if any, may be the same or different.

Two or more of the compounds represented by the general formula (a) may be used in combination. In particular, the compound represented by the general formula (b) is synthesized from two compounds represented by the general formula (a) as starting materials. Specific examples of the compound represented by the general formula (a) and the starting material of the compound represented by the general formula (b) will be given below, but the invention is not limited thereto.

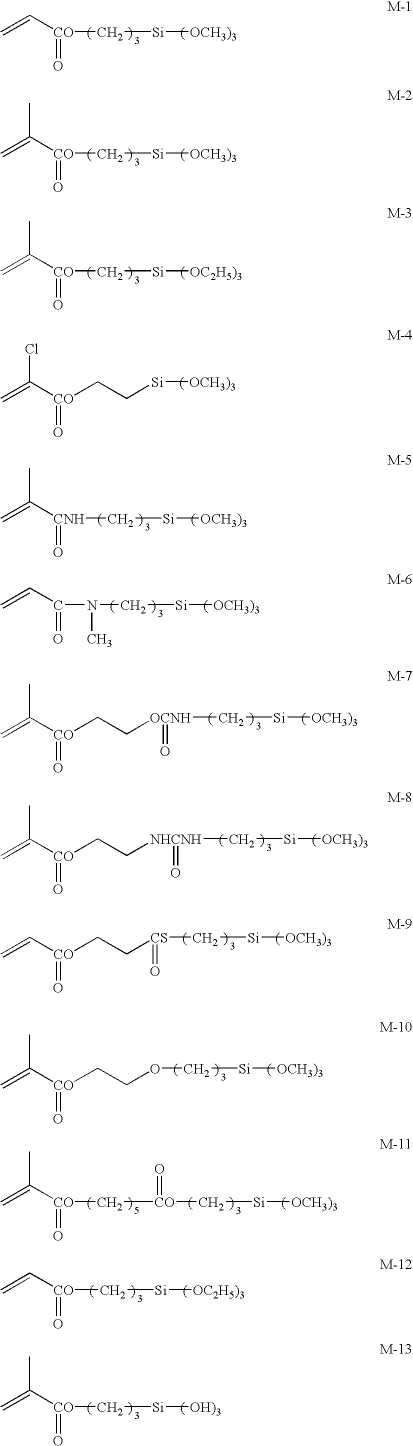

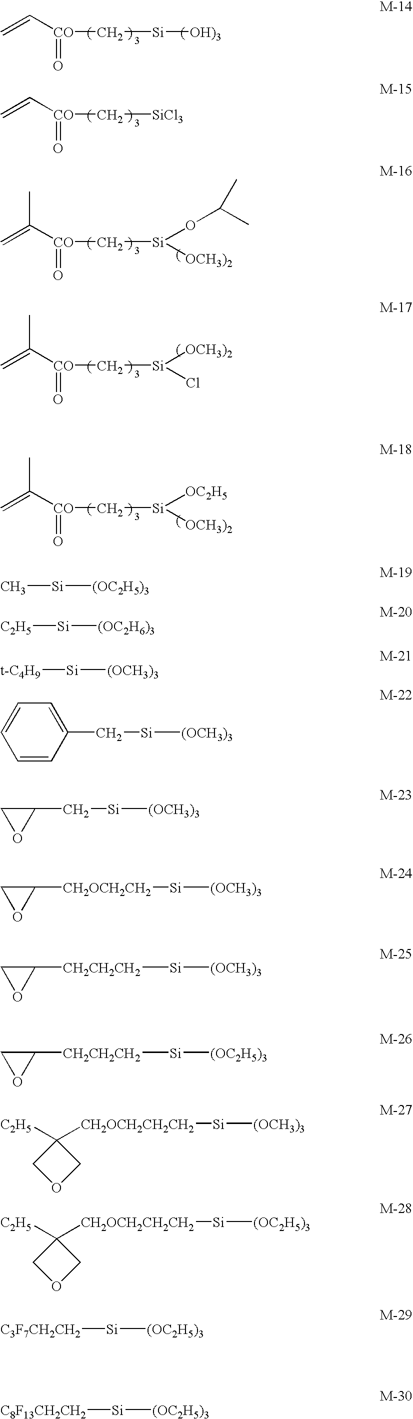

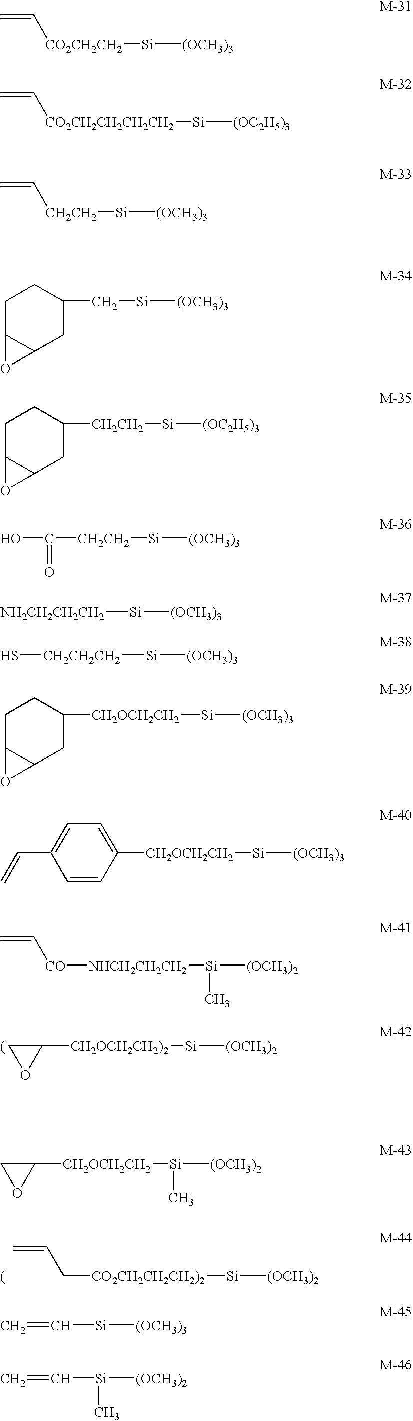

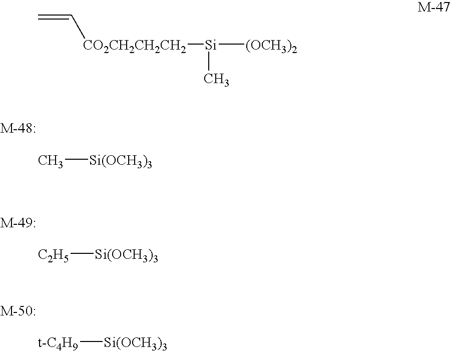

Particularly preferred among these compounds are compounds (M-1), (M-2), (M-25), (M-48), and (M-49).

In order to exert the effect of the invention, the content of the aforementioned organosilane having a vinyl-polymerizable group in the hydrolyzate and/or partial condensate of organosilane is preferably from 30% to 100% by mass, more preferably from 50% to 100% by mass, even more preferably from 70% to 100% by mass, particularly from 90% to 100% by mass. The content of organosilane having the vinyl-polymerizable group is preferably 30% by mass or more from the aspect of production of a solid content, deterioration of the pot life and control of the molecular weight, and because enhancement of the properties (e.g., scratch resistance of anti-reflection layer) if polymerization is effected are easily attained due to a small content of the polymerization group.

At least any of the hydrolyzate and partial condensate of organosilane of the invention preferably has a reduced volatility. In some detail, the volatility of the product at 105° C. per hour is preferably 5% by mass or less, 3% by mass or less, particularly 1% by mass or less.

The sol component to be used in the invention is prepared by the hydrolysis and/or partial condensation of the aforementioned organosilane.

The hydrolytic condensation reaction is effected with stirring at a temperature of from 25° C. to 100° C. with water added in an amount of from 0.05 to 2.0 mols and preferably 0.1 to 1.0 mols per mol of hydrolyzable group (X) in the presence of the catalyst to be used in the invention.

In at least any of the hydrolyzate and partial condensate of the organosilane of the invention, the weight-average molecular weight of any of the hydrolyzate and partial condensate of organosilane having a vinyl-polymerizable group is preferably from 450 to 20,000, more preferably from 500 to 10,000, even more preferably from 550 to 5,000, still more preferably from 600 to 3,000, if components having a molecular weight of less than 300 are excluded.

The proportion of the components having a molecular weight of more than 20,000 in the components having a molecular weight of 300 or more among the hydrolyzate and/or partial condensate of organosilane is preferably 10% by mass or less, more preferably 5% by mass or less, even more preferably 3% by mass or less. 10% or more of the components is preferred from the aspect of transparency or adhesion to substrate of the cured layer obtained by curing a curable composition containing such a hydrolyzate and/or partial condensate of organosilane.

The term “weight-average molecular weight” as used herein is meant to indicate a molecular weight as calculated in terms of polystyrene measured by detection by differential refractometer in THF as solvent using a GPC analyzer comprising TSKgel GMHxL, TSKgel G4000HxL and TSKgel G2000HxL columns (produced by TOSOH CORPORATION). The content is represented by the percent area of the peak falling within the above defined molecular weight range supposing that the area of the peak corresponding to the component having a molecular weight of 300 or more is 100%.

The degree of dispersion (weight-average molecular weight/number-average molecular weight) is preferably from 3.0 to 1.1, more preferably from 2.5 to 1.1, further more preferably from 2.0 to 1.1, particularly preferably from 1.5 to 1.1.

By subjecting the hydrolyzate and partial condensate of organosilane of the invention to ²⁹Si—NMR analysis, it can be confirmed that Z in the general formula (a) is condensed in the form of OSi.

Supposing that T3 indicates the case where the three bonds of Si are condensed in the form of —OSi, T2 indicates the case where the two bonds of Si are condensed in the form of —OSi, T1 indicates the case where one bond of Si is condensed in the form of —OSi and T0 indicates the case where Si is not condensed, the percent condensation α is represented by the numerical formula (II): α=(T×3+T2×2+T1×1)/3/(T3+T2+T1+T0). The percent condensation is preferably from 0.2 to 0.95, more preferably from 0.3 to 0.93, particularly from 0.4 to 0.9.

The percent condensation is preferably within the above-mentioned range from the aspect of suitable progress of hydrolysis or condensation, suitable progress of curing based on the amount of monomer components, and the prevention of the deterioration of mutual interaction of binder polymer, resin substrate, inorganic particulate material, etc.

The hydrolyzate and partial condensate of organosilane compound to be used in the invention will be further described hereinafter.

The hydrolyzation and subsequent condensation reaction of organosilane compound is normally effected in the presence of a catalyst. Examples of the catalyst employable herein include inorganic acids such as hydrochloric acid, sulfuric acid and nitric acid, organic acids such as oxalic acid, acetic acid, butyric acid, maleic acid, citric acid, formic acid, methanesulfonic acid and toluenesulfonic acid, inorganic bases such as sodium hydroxide, potassium hydroxide and ammonia, organic bases such as triethylamine and pyridine, metal alkoxides such as triisopropoxy aluminum and tetrabutoxy zirconium, metal chelate compounds comprising a metal such as zirconium, titanium and aluminum as a central metal, and fluorine-containing compounds such as KF and NH₄F.

The aforementioned catalysts may be used singly or in combination.

The hydrolyzation/condensation reaction of organosilane may be effected in the absence or presence of solvent. However, an organic solvent is preferably used to uniformly mix the components. Preferred examples of the organic solvent include alcohols, aromatic hydrocarbons, ethers, ketones, and esters.

As the solvent there is preferably used one capable of dissolving the organosilane and the catalyst therein. Alternatively, the organic solvent is preferably used as a coating compound or a part thereof from the standpoint of process. The solvent to be used herein preferably doesn't impair solubility or dispersibility when mixed with other materials such as fluorine-containing polymer.

Examples of alcohols among these solvents include monovalent and divalent alcohols. As the monovalent alcohol there is preferably used a C₁-C₈ saturated aliphatic alcohol.

Specific examples of these alcohols include methanol, ethanol, n-propyl alcohol, i-propyl alcohol, n-butyl alcohol, sec-butyl alcohol, tert-butyl alcohol, ethylene glycol, diethylene glycol, triethylene glycol, ethylene glycol monobutyl ether, and ethylene glycol monoethyl ether acetate.

Specific examples of the aromatic hydrocarbons include benzene, toluene, and xylene. Specific examples of the ethers include tetrahydrofurane, and dioxane. Specific examples of ketones include acetone, methyl ethyl ketone, diisobutyl ketone, and cyclohexanone. Specific examples of the esters include ethyl acetate, propyl acetate, butyl acetate, and propylene carbonate.

These organic solvents may be used singly or in combination of two or more thereof. The solid content concentration in the aforementioned reaction is not specifically limited but is normally from 1% to 100%.

In some detail, the hydrolyzation/condensation reaction is effected with stirring at a temperature of from 25° C. to 100° C. with water added in an amount of from 0.05 to 2 mols, preferably from 0.1 to 1 mols per mol of the hydrolyzable group in the organosilane compound in the absence or presence of the aforementioned solvent in the presence of a catalyst.

In the invention, hydrolyzation is preferably effected with stirring at a temperature of from 25° C. to 100° C. in the presence of at least one metal chelate compound comprising an alcohol represented by the general formula R³OH (in which R³ represents a C₁-C₁₀ alkyl group) and a compound represented by the general formula R⁴COCH₂COR⁵ (in which R⁴ represents a C₁-C₁₀ alkyl group and R⁵ represents a C₁-C₁₀ alkyl or alkoxy group) as ligands and a metal selected from the group consisting of zirconium, titanium and aluminum as a central metal.

Alternatively, since the fluorine-containing compound, if used as catalyst, is capable of causing full progress of hydrolysis/condensation, the polymerization degree can be properly determined by selecting the amount of water to be added, making it possible to predetermine arbitrary molecular weight to advantage. In other words, in order to prepare a organosilane hydrolyzate/partial condensate having an average polymerization degree M, water may be used in an amount of (M−1) mols per M mols of hydrolyzable organosilane.

As the metal chelate compound there may be used without any special limitation any metal chelate compound so far as it comprises an alcohol represented by the general formula R³OH (in which R³ represents a C₁-C₁₀ alkyl group) and a compound represented by the general formula R⁴COCH₂COR⁵ (in which R⁴ represents a C₁-C₁₀ alkyl group and R⁵ represents a C₁-C₁₀ alkyl or alkoxy group) as ligands and a metal selected from the group consisting of zirconium, titanium and aluminum as a central metal. So far as these requirements are satisfied, two or more metal chelate compounds may be used in combination. As the metal chelate compound there is preferably used one selected from the group consisting of compounds represented by the following general formulae:
Zr(OR³)ₚ₁(R⁴COCHCOR⁵)ₚ₂;
Ti(OR³)_{q1}(R⁴COCHCOR⁵)_{q2}; and
Al(OR³)ᵣ₁(R⁴COCHCOR⁵)ᵣ₂
The metal chelate compound acts to accelerate the condensation reaction of the hydrolyzate and partial condensate of organosilane compound.

Each of R³'s and R⁴'s in the metal chelate compound, if any, may be the same or different and each represent a C₁-C₁₀ alkyl group such as ethyl group, n-propyl group, i-propyl group, n-butyl group, sec-butyl group, t-butyl group, n-pentyl group and phenyl group. R⁵'s, if any, may be the same or different, and each represents the aforementioned C₁-C₁₀ alkyl group or a C₁-C₁₀ alkoxy group such as methoxy group, ethoxy group, n-propoxy group, i-propoxy group, n-butoxy group, sec-butoxy group and t-butoxy group. The suffixes p1, p2, q1, q2, r1 and r2 in the metal chelate compound each represent an integer satisfying the equations p1+p2=4, q1+q2=4 and r1+r2=3.

Specific examples of these metal chelate compounds include zirconium chelate compounds such as tri-n-butoxy ethyl acetoacetate zirconium, di-n-butoxybis(ethyl acetoacetate)zirconium, n-butoxytris(ethylaceto acetate)zirconium, tetrakis(n-propylacetoacetate) zirconium, tetrakis(acetylacetoacetate)zirconium and tetrakis(ethylacetoacetate)zirconium, titanium compounds such as diisopropoxy bis(ethylacetoacetate) titanium, diisopropoxy bis(acetylacetate)titanium and diisopropoxy bis(acetylacetone)titanium, and aluminum chelate compounds such as diisopropoxyethyl acetoacetate aluminum, diisopropoxyacetylacetonate aluminum, isopropoxy bis(ethylacetoacetate)aluminum, isoproposy bis(acetylacetonate)aluminum, tris(ethyl acetoacetate)aluminum, tris(acetylacetonate)aluminum and monoacetyl acetonate bis(ethylacetoacetate) aluminum.

Preferred among these metal chelate compounds are tri-n-butoxyethyl acetoacetate zirconium, diisopropoxy bis(acetylacetonate)titanium, diisopropoxy ethyl acetoacetate aluminum and tris(ethylacetoacetate) aluminum. These metal chelate compounds may be used singly or in combination of two or more thereof. Alternatively, these metal chelate compounds may be used in the form of partial hydrolyzate.

The metal chelate compounds are preferably used in an amount of from 0.01 to 50% by mass, more preferably from 0.1 to 50% by mass, even more preferably from 0.5 to 10% by mass based on the weight of the organosilane compound. When the amount of the metal chelate compounds falls within the aforementioned range, the condensation reaction of the organosilane compound proceeds at a high rate to provide a coat layer with an excellent durability. Further, the resulting composition containing the hydrolyzate and partial condensate of organosilane compound and a metal chelate compound exhibits an excellent storage stability to advantage.

The coating solution for functional layer and low refractive index layer to be used in the invention preferably comprises at least any of β-diketone compounds and β-ketoester compounds incorporated therein in addition to the aforementioned composition containing a sol component and a metal chelate compound. These components will be further described hereinafter.

In the invention, at least any of β-diketone compounds and β-ketoester compounds represented by the general formula R⁴COCH₂COR⁵ is preferably used. It acts as a stability improver for the composition of the invention. It is thought that these compounds are coordinated to the metal atom in the aforementioned metal chelate compound (at least one of zirconium, titanium and aluminum compounds) to inhibit the acceleration of the condensation reaction of the derivatives (hydrolyzate, partial condensate) of organosilane compound by these metal chelate compounds and hence enhance the storage stability of the resulting composition. R⁴ and R⁵ constituting these β-diketone compounds and β-ketoester compounds have the same meaning as R⁴ and R⁵ constituting the aforementioned metal chelate compound.

Specific examples of the β-diketone compounds and β-ketoester compounds include acetyl acetone, methyl acetoacetate, ethyl acetoacetate, n-propyl acetoacetate, i-propyl acetoacetate, n-butyl acetoacetate, sec-butyl acetoacetate, t-butyl acetoacetate, 2,4-hexane-dione, 2,4-heptane-dione, 3,5-heptane-dione, 2,4-octane-dione, 2,4-nonane-dione, and 5-methyl-hexane-dione. Preferred among these compounds are ethyl acetoacetate and acetyl acetone. Particularly preferred among these compounds is acetyl acetone. These β-diketone compounds and/or β-ketoester compounds may be used singly or in combination of two or more thereof. In the invention, the β-diketone compounds and β-ketoester compounds are preferably used in an amount of 2 mols or more, more preferably from 3 to 20 mols per mol of metal chelate compound from the aspect of preservation stability of the obtained compound. When the amount of these compounds falls below 2 mols, the resulting composition can exhibit a deteriorated storage stability to disadvantage.

The content of the hydrolyzate and partial condensate of the organosilane is preferably low in the low refractive index layer that is relatively a thin film but is preferably high in a functional film that is a thick layer. The content amount of these compounds is preferably from 0.1 to 50% by mass, more preferably from 0.5 to 30% by mass and from 1 to 15% by mass based on the total solid content in the containing layer (added layer), taking into consideration the attainment of the effect, refractive index, and the shape and the surface shape of the film.

At least one compound selected from the group consisting of the organosilane compounds and derivatives thereof preferably undergoes crosslinking or polymerization reaction with other components of the layer in which they are incorporated to allow extreme enhancement of the physical strength (e.g., scratch resistance) of the film. To this end, the organosilane compound to be used preferably has a crosslinking or polymerizable functional group. Further, as the inorganic particulate material or binder there is preferably used a compound having a functional group that undergoes crosslinking or polymerization with the organosilane compound.

The organosilane compound is preferably incorporated in the antistatic layer, hard coat layer, anti-glare layer, light diffusion layer, high refractive index layer, low refractive index layer and outermost layer, more preferably hard coat layer, anti-glare layer, light diffusion layer, low refractive index layer and outermost layer, particularly outermost layer and layer adjacent thereto.

(Method for the Formation of Anti-Reflection Film, etc.)

The various layers constituting the anti-reflection layer of the invention are preferably prepared by the coating method. In the case where the coating method is used, the various layers can be prepared by a dip coating method, an air knife coating method, a curtain coating method, a roller coating method, a wire bar coating method, a gravure coating method, a microgravure coating method, an extrusion coating method (as disclosed in U.S. Pat. No. 2,681,294) or a die coating method (as disclosed in JP-A-2003-20097, JP-A-2003-211052, JP-A-2003-236434, JP-A-2003-260400, and JP-A-2003-260402). Two or more coating compositions may be simultaneously spread. For the details of the simultaneous coating method, reference can be made to U.S. Pat. Nos. 2,761,791, 2,941,898, 3,508,947 and 3,526,528, and Yuji Harasaki, “Kotingu Kogaku (Coating Engineering)”, Asakura Shoten, page 253, 1973. Preferred among these coating methods are wire bar coating method, gravure coating method, microgravure coating method, and die coating method. Particularly preferred among these coating methods are microgravure coating method and die coating method.

In accordance with the microgravure coating method, a gravure roll having a diameter of from about 10 mm to 100 mm, preferably from about 20 mm to 50 mm, and having a gravure pattern stamped on the entire circumference thereof disposed under the support is rotated in the direction opposite the conveying direction of the support. At the same time, the extra coating solution is scraped off the surface of the gravure roll by means of a doctor blade. In this manner, a constant amount of the coating solution is transferred to the support to form a coat layer.

In the microgravure coating method, the number of lines in the gravure pattern stamped on the gravure roll is preferably from 50 to 800 per inch, more preferably from 100 to 300 per inch. The depth of the gravure pattern is preferably from 1 μm to 600 μm, more preferably from 5 μm to 200 μm. The rotary speed of the gravure roll is preferably from 3 rpm to 800 rpm, more preferably from 5 rpm to 200 rpm. The conveying speed of the support is preferably from 0.5 to 100 m/min, more preferably from 1 to 50 m/min.

In accordance with the die coating method, the coating solution from a slot die having a pocket formed therein is spread in the form of bead over a web which is continuously running while being supported on a back-up roller to form a coat layer on the web. By properly adjusting the distance between the forward end of the slot die and the web on the upstream side and downstream side of the slot member in the web running direction, the spreading can be conducted with a good precision to a wet thickness of scores of micrometer.

The coating compound to be used in the preparation of the layers of the anti-reflection film by coating method preferably comprises a surface condition improver incorporated therein. The surface condition improver will be described hereinafter.

(Surface Condition Improver)

The coating compound to be used in the preparation of any layer on the transparent support preferably comprises any of fluorine-containing and silicone-based surface condition improvers incorporated therein to eliminate defects in surface conditions (unevenness in coating, unevenness in drying, point defect).

The surface condition improver preferably causes the change of the surface tension of the coating compound by 1 mN/m or more. The term “change of the surface tension of the coating compound by 1 mN/m or more” as used herein is meant to indicate that the surface tension of the coating compound having a surface condition improver incorporated therein shows a change of 1 mN/m or more from that of the coating compound free of surface condition improver, including at the concentration step during spreading/drying.

The surface condition improver to be used herein preferably has an effect of reducing the surface tension of the coating compound by 1 mN/m or more, more preferably 2 mN/m or more, particularly 3 mN/m or more.

Preferred examples of the fluorine-containing surface condition improver include compounds containing a fluoroaliphatic group (hereinafter abbreviated as “fluorine-based surface condition improver”). Particularly preferred examples of these compounds include acrylic and methacrylic resins containing a repeating unit corresponding to the monomer of the following general formula (i) and a repeating unit corresponding to the monomer of the following general formula (ii), and copolymers thereof with vinyl-based monomer copolymerizable therewith.

As these monomers there are preferably used those disclosed in “Polymer Handbook”, 2nd ed., J. Brandrup, Wiley Interscience (1975), Chapter 2, pp. 1 to 483.

Examples of these monomers include compounds having one addition-polymerizable unsaturated bond selected from the group consisting of acrylic acid, methacrylic acid, acrylic acid esters, methacrylic cid esters, acrylamides, methacrylamides, allyl compounds, vinyl ethers and vinyl esters. 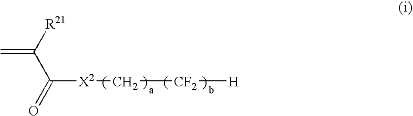
wherein R²¹ represents a hydrogen atom, halogen atom or methyl group, preferably hydrogen atom or methyl group; X² represents an oxygen atom, sulfur atom or —N(R²²)—, oxygen atom or —N(R²²)—, particularly oxygen atom; R²² represents a hydrogen atom or C₁-C₈ alkyl group, preferably hydrogen atom or C₁-C₄ alkyl group, particularly hydrogen atom or methyl group; the suffix a represents an integer of from 1 to 6, preferably from 1 to 3, particularly 1; and the suffix b represents an integer of from 1 to 18, preferably from 4 to 12, particularly from 6 to 8.

The fluorine-based surface condition improver may comprise two or more fluoroaliphatic group-containing monomers represented by the following general formula (ii) incorporated therein as constituent.

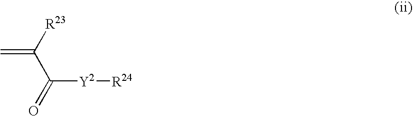

In the general formula (ii), R²³ represents a hydrogen atom, halogen atom or methyl group, preferably hydrogen atom or methyl group. Y² represents an oxygen atom, sulfur atom or —N(R²⁵)—, preferably oxygen atom or —N(R²⁵)—, particularly oxygen atom. R²⁵ represents a hydrogen atom or C₁-C₈ alkyl group, preferably hydrogen atom or C₁-C₄ alkyl group, particularly hydrogen atom or methyl group.

R²⁴ represents a hydrogen atom, substituted or unsubstituted C₁-C₂₀ straight-chain, branched or cyclic alkyl group, alkyl group containing a poly(alkyleneoxy) group or substituted or unsubstituted aromatic group (e.g., phenyl group, naphthyl group), preferably C₁-C₁₂ straight-chain, branched or cyclic alkyl group or an aromatic group having from 6 to 18 carbon atoms in total, more preferably C₁-C₈ straight-chain, branched or cyclic alkyl group. The poly(alkyleneoxy) group will be further described hereinafter.

The poly(alkyleneoxy) group is a group comprising —(OR)— group as repeating unit. R represents an alkylene group having from 2 to 4 carbon atoms such as —CH₂CH₂—, —CH₂CH₂CH₂—, —CH(CH₃)CH₂— and —CH(CH₃)CH(CH₃)—.

The oxyalkylene unit (—OR—) in the aforementioned poly(oxyalkylene) group may be the same as in poly(oxypropylene), may have two or more oxyalkylenes distributed irregularly therein, may be a straight-chain or branched oxypropylene or oxyethylene unit or may be present like block of straight-chain or branched oxypropylene unit or block of oxyethylene unit.

This poly(oxyalkylene) chain may also have one or chain bonds (e.g., —CONH-Ph-NHCO—, —S—: Ph represents a phenylene group) connected to each other. In the case where the chain bond has a valency of 3 or more, this poly(oxyalkylene) chain provides a means of providing a branched oxyalkylene unit. In the case where this copolymer is used in the invention, the molecular weight of the poly(oxyalkylene) group is preferably from 250 to 3,000.

The poly(oxyalkylene) acrylate and methacrylate can be produced by reacting a commercially available hydroxypoly(oxyalkylene) material such as “Pluronic” (produced by ASAHI DENKA Co., Ltd.), Adekapolyether (produced by ASAHI DENKA Co., Ltd.), “Carbowax” (produced by Glico Products Co., Ltd.), “Toriton” (produced by Rohm and Haas Co., Ltd.) and P.E.G (produced by DAI-ICHI KOGYO SEIYAKU CO., LTD.) with acrylic acid, methacrylic acid, acryl chloride, methacryl chloride or acrylic anhydride by a known method. Alternatively, a poly(oxyalkylene)diacrylate produced by a known method may be used.

Referring to the fluorine-based surface condition improver to be used in the invention, the content of the fluoroaliphatic group-containing monomer represented by the general formula (i) based on the total amount of the monomers to be used in the preparation of the fluorine-based surface condition improver is preferably 50 mol-% or more, more preferably from 70 to 100 mol-%, particularly from 80 to 100 mol-%.

The weight-average molecular weight of the fluorine-based surface condition improver to be used in the invention is preferably from 3,000 to 100,000, more preferably from 6,000 to 80,000, even more preferably from 8,000 to 60,000.

The term “weight-average molecular weight” as used herein is meant to indicate a molecular weight as calculated in terms of polystyrene measured by detection by differential refractometer in THF as solvent using a GPC analyzer comprising TSKgel GMHxL, TSKgel G4000HxL and TSKgel G2000HxL columns (produced by TOSOH CORPORATION). The content is represented by the percent area of the peak falling within the above defined molecular weight range supposing that the area of the peak corresponding to the component having a molecular weight of 300 or more is 100%.

Further, the added amount of the fluorine-based surface condition improver to be used in the invention is preferably from 0.001 to 5% by mass, more preferably from 0.005 to 3% by mass, even more preferably from 0.01 to 1% by mass based on the weight of the coating compound of the layer in which it is incorporated.

Specific examples of the structure of the fluorine-based surface condition improver of the invention will be given below, but the invention is not limited thereto. The figure in these formulae each indicate the molar ratio of the various monomer components. Mw indicates the weight-average molecular weight of the compound.

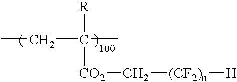

| | R | n | Mw |
|---|---|---|---|
| F-1 | H | 4 | 8000 |
| F-2 | H | 4 | 16000 |
| F-3 | H | 4 | 33000 |
| F-4 | CH₃ | 4 | 12000 |
| F-5 | CH₃ | 4 | 28000 |
| F-6 | H | 6 | 8000 |
| F-7 | H | 6 | 14000 |
| F-8 | H | 6 | 29000 |
| F-9 | CH₃ | 6 | 10000 |
| F-10 | CH₃ | 6 | 21000 |
| F-11 | H | 8 | 4000 |
| F-12 | H | 8 | 16000 |
| F-13 | H | 8 | 31000 |
| F-14 | CH₃ | 8 | 3000 |

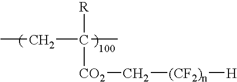

| | R | n | Mw |
|---|---|---|---|
| F-15 | CH₃ | 8 | 10000 |
| F-16 | CH₃ | 8 | 27000 |
| F-17 | H | 10 | 5000 |
| F-18 | H | 10 | 11000 |
| F-19 | CH₃ | 10 | 4500 |
| F-20 | CH₃ | 10 | 12000 |
| F-21 | H | 12 | 5000 |
| F-22 | H | 12 | 10000 |
| F-23 | CH₃ | 12 | 5500 |
| F-24 | CH₃ | 12 | 12000 |

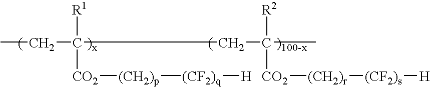

| | x | R¹ | p | q | R² | r | s | Mw |
|---|---|---|---|---|---|---|---|---|
| F-25 | 50 | H | 1 | 4 | CH₃ | 1 | 4 | 10000 |
| F-26 | 40 | H | 1 | 4 | H | 1 | 6 | 14000 |
| F-27 | 60 | H | 1 | 4 | CH₃ | 1 | 6 | 21000 |
| F-28 | 10 | H | 1 | 4 | H | 1 | 8 | 11000 |
| F-29 | 40 | H | 1 | 4 | H | 1 | 8 | 16000 |
| F-30 | 20 | H | 1 | 4 | CH₃ | 1 | 8 | 8000 |
| F-31 | 10 | CH₃ | 1 | 4 | CH₃ | 1 | 8 | 7000 |
| F-32 | 50 | H | 1 | 6 | CH₃ | 1 | 6 | 12000 |
| F-33 | 50 | H | 1 | 6 | CH₃ | 1 | 6 | 22000 |
| F-34 | 30 | H | 1 | 6 | CH₃ | 1 | 6 | 5000 |

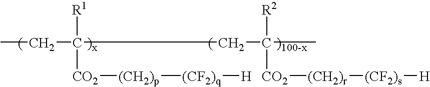

| | x | R¹ | p | q | R² | r | s | Mw |
|---|---|---|---|---|---|---|---|---|
| F-35 | 40 | CH₃ | 1 | 6 | H | 3 | 6 | 3000 |
| F-36 | 10 | H | 1 | 6 | H | 1 | 8 | 7000 |
| F-37 | 30 | H | 1 | 6 | H | 1 | 8 | 17000 |
| F-38 | 50 | H | 1 | 6 | H | 1 | 8 | 16000 |
| F-39 | 50 | CH₃ | 1 | 6 | H | 3 | 8 | 19000 |
| F-40 | 50 | H | 1 | 8 | CH₃ | 1 | 8 | 5000 |
| F-41 | 80 | H | 1 | 8 | CH₃ | 1 | 8 | 10000 |
| F-42 | 50 | CH₃ | 1 | 8 | H | 3 | 8 | 14000 |
| F-43 | 90 | H | 1 | 8 | CH₃ | 3 | 8 | 9000 |
| F-44 | 70 | H | 1 | 8 | H | 1 | 10 | 7000 |
| F-45 | 90 | H | 1 | 8 | H | 3 | 10 | 12000 |
| F-46 | 50 | H | 1 | 8 | H | 1 | 12 | 10000 |
| F-47 | 70 | H | 1 | 8 | CH₃ | 3 | 12 | 8000 |

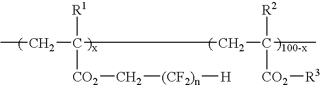

| | x | R¹ | n | R² | R³ | Mw |
|---|---|---|---|---|---|---|
| F-48 | 80 | H | 4 | CH₃ | CH₃ | 11000 |
| F-49 | 90 | H | 4 | H | C₄H₉(n) | 7000 |
| F-50 | 95 | H | 4 | H | C₆H₁₃(n) | 5000 |
| F-51 | 90 | CH₃ | 4 | H | CH₂CH(C₂H₅)C₄H₉(n) | 15000 |
| F-52 | 70 | H | 6 | CH₃ | C₂H₅ | 18000 |
| F-53 | 90 | H | 6 | CH₃ | 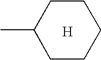 | 12000 |
| F-54 | 80 | H | 6 | H | C₄H₉(sec) | 9000 |
| F-55 | 90 | H | 6 | H | C₁₂H₂₅(n) | 21000 |
| F-56 | 60 | CH₃ | 6 | H | CH₃ | 15000 |
| F-57 | 60 | H | 8 | H | CH₃ | 10000 |
| F-58 | 70 | H | 8 | H | C₂H₅ | 24000 |
| F-59 | 70 | H | 8 | H | C₄H₉(n) | 5000 |
| F-60 | 50 | H | 8 | H | C₄H₉(n) | 16000 |
| F-61 | 80 | H | 8 | CH₃ | C₄H₉(Iso) | 13000 |
| F-62 | 80 | H | 8 | CH₃ | C₄H₉(t) | 9000 |
| F-63 | 60 | H | 8 | H | 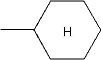 | 7000 |
| F-64 | 80 | H | 8 | H | CH₂CH(C₂H₅)C₄H₉(n) | 8000 |
| F-65 | 90 | H | 8 | H | C₁₂H₂₅(n) | 6000 |

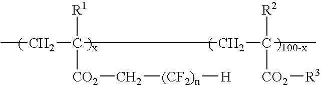

| | x | R¹ | n | R³ | R³ | Mw |
|---|---|---|---|---|---|---|
| F-66 | 80 | CH₃ | 8 | CH₃ | C₄H₉(sec) | 18000 |
| F-67 | 70 | CH₃ | 8 | CH₃ | CH₃ | 22000 |
| F-68 | 70 | H | 10 | CH₃ | H | 17000 |
| F-69 | 90 | H | 10 | H | H | 9000 |

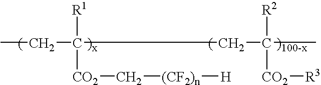

| | x | R¹ | n | R² | R³ | Mw |
|---|---|---|---|---|---|---|
| F-70 | 95 | H | 4 | CH₃ | —(CH₂CH₂O)₂—H | 18000 |
| F-71 | 80 | H | 4 | H | —(CH₂CH₂O)₂—CH₃ | 16000 |
| F-72 | 80 | H | 4 | H | —(C₃H₆O)₇—H | 24000 |
| F-73 | 70 | CH₃ | 4 | H | —(C₃H₆O)₁₃—H | 18000 |
| F-74 | 90 | H | 6 | H | —(CH₂CH₂O)₂—H | 21000 |
| F-75 | 90 | H | 6 | CH₃ | —(CH₂CH₂O)₈—H | 9000 |
| F-76 | 80 | H | 6 | H | —(CH₂CH₂O)₂—C₄H₉(n) | 12000 |
| F-77 | 80 | H | 6 | H | —(C₃H₆O)₇—H | 34000 |
| F-78 | 75 | F | 6 | H | —(C₃H₆O)₁₃—H | 11000 |
| F-79 | 85 | CH₃ | 6 | CH₃ | —(C₃H₆O)₂₀—H | 18000 |
| F-80 | 95 | CH₃ | 6 | CH₃ | —CH₂CH₂OH | 27000 |
| F-81 | 80 | H | 8 | CH₃ | —(CH₂CH₂O)₈—H | 12000 |
| F-82 | 95 | H | 8 | H | —(CH₂CH₂O)₉—CH₃ | 20000 |
| F-83 | 90 | H | 8 | H | —(C₃H₆O)₇—H | 8000 |

The surface condition improver of the invention is preferably incorporated in a coating compound containing a ketone-based solvent (e.g., acetone, methyl ethyl ketone, methyl isobutyl ketone, cyclohexanone), an ester-based solvent (e.g., ethyl acetate, butyl acetate), an ether (e.g., tetrahydrofurane, 1,4-dioxane) and an aromatic hydrocarbon-based solvent (e.g., toluene, xylene), particularly ketone-based solvent. Preferred among these ketone-based solvents are methyl ethyl ketone, methyl isobutyl ketone, and cyclohexanone.

Further, a coating compound containing a ketone-based solvent in an amount of 10% by mass or more, more preferably 30% by mass or more, even more preferably 60% by mass or more based on the total weight of the solvents is preferably used.

As solvents for the coating compound there may be used solvents other than ketone-based solvent. Examples of these solvents include water, alcohols (e.g., methanol, ethanol, isopropanol, butanol, benzyl alcohol), esters (e.g., methyl acetate, ethyl acetate, propyl acetate, butyl acetate, methyl formate, ethyl formate, propyl formate, butyl formate), aliphatic hydrocarbons (e.g., hexane, cyclohexane), halogenated hydrocarbons (e.g., methylene chloride, chloroform, carbon tetrachloride), aromatic hydrocarbons (e.g., benzene, toluene, xylene), amides (e.g., dimethyl formamide, dimethyl acetamide, n-methylpyrrolidone), ethers (e.g., diethyl ether, dioxane, tetrahydrofurane), and ether alcohols (e.g., 1-methoxy-2-propanol).

A surface condition improver may deteriorate the adhesivity of interface of layers. Accordingly, it is preferred that the surface condition improver present on the surface of the layer be eluted with the coating compound constituting the layer adjacent to the aforementioned layer so that it doesn't leave in the vicinity of the interface of the layers. It is thus preferred that the coating compound for the adjacent layer comprise a solvent dissolved therein capable of dissolving a surface condition improver. As such a solvent there is preferably used the aforementioned ketone-based solvent.

It is particularly preferred that the surface condition improver be incorporated in the coating compound for hard coat layer, anti-glare layer, antistatic layer, high refractive index layer and low refractive index layer, particularly hard coat layer and anti-glare layer, among the layers formed on the transparent support.

(Physical Properties of Anti-Glare Anti-Reflection Film)

The anti-reflection film according to the invention preferably exhibits a dynamic friction coefficient of 0.25 or less, more preferably 0.17 or less, particularly 0.15 or less on the surface thereof on the outermost coat layer side to enhance the physical strength (e.g., scratch resistance) thereof. The term “dynamic friction coefficient” as used herein is meant to indicate the dynamic friction coefficient of the surface on the outermost layer side thereof with respect to a stainless steel sphere having a diameter of 5 mm developed when the stainless steel sphere is moved along the surface of the low refractive index layer at a speed of 60 cm/min under a load of 0.98 N.

Further, the anti-reflection film preferably exhibits a contact angle of 80° or more, more preferably 90° or more, particularly 100° or more with respect to water on the surface on the outermost layer side thereof to enhance the stainproofness thereof.

The haze of the anti-reflection film according to the invention is preferably from 0.5% to 60%, more preferably from 1% to 50%, most preferably from 1% to 40%.

The reflectance of the anti-reflection film according to the invention is preferably as low as possible, more preferably 3.0% or less, even more preferably 2.5% or less, still more preferably 2.0% or less, particularly 1.5% or less.

(Protective Film for Polarizing Plate)

The anti-reflection film of the invention can be used as a protective film for polarizing layer (protective film for polarizing plate). In this case, the anti-reflection film of the invention preferably exhibits a contact angle of 40° or less, more preferably 30° or less, particularly 25° or less with respect to water on the surface of the transparent support on the side opposite the outermost layer, i.e., side on which it is stuck to the polarizing layer. The reduction of the contact angle to 40° or less is advantageous in the enhancement of the adhesivity to the polarizing layer mainly composed of polyvinyl alcohol. The contact angle can be adjusted by the following saponification conditions.

As the transparent support for the anti-reflection film to be used as protective film for polarizing plate there is particularly preferably used a triacetyl cellulose film.

As methods of preparing the protective film for polarizing plate of the invention there can be proposed two methods, i.e., (1) method which comprises spreading the coating solution of the aforementioned layers (e.g., antistatic layer, hard coat layer, anti-glare layer, low refractive index layer, high refractive index layer, outermost layer) over one side of a transparent support which has been previously saponified and (2) method which comprises spreading the coating solution of the aforementioned layers (e.g., antistatic layer, hard coat layer, anti-glare layer, low refractive index layer, outermost layer) over one side of a transparent support, and then saponifying the transparent support on the side thereof on which it is stuck to the polarizing layer.

In the method (1), in the case where only one side of the transparent support has been saponified, the coating solution of the various layers are spread over the unsaponified side of the transparent support. In the case where the transparent support has been saponified on the both sides thereof, the saponified surface of the transparent support on the side on which the various layers are provided is subjected to surface treatment involving corona discharge treatment, glow discharge treatment, flame treatment or the like before the spreading of the various layer coating solutions.

In the method (2), it is preferred that the anti-reflection film be entirely dipped in a saponifying solution. In this case, the anti-reflection film may be dipped in a saponifying solution with the side thereof having various layers being protected by a protective film to saponify the surface of the transparent support on the side thereof on which it is stuck to the polarizing layer.

Further, a saponifying solution may be spread over the surface of the transparent support of the anti-reflection film on the side thereof on which it is stuck to the polarizing layer to saponify the side of the anti-reflection film on which it is stuck to the polarizing layer.

The saponification may be effected after the provision of the protective film with anti-reflection properties, making it possible to further reduce cost. In this respect, the method (2) is desirable because the protective film for polarizing plate can be produced at reduced cost.

The protective film for polarizing plate preferably satisfies requirements described with reference to the anti-reflection film of the invention with respect to optical properties (e.g., low reflectance, anti-glare properties), physical properties (e.g., scratch resistance), chemical resistance, stainproofness (e.g., stain resistance), weathering resistance (resistance to moisture heat, light resistance) and dustproofness.

The surface resistivity of the protective film on the side having the outermost layer is preferably 1×10¹³ Ω/sq. or less, more preferably 1×10¹² Ω/sq. or less, even more preferably 1×10¹⁰ Ω/sq. or less.

The dynamic friction coefficient of the protective film on the side having the outermost layer is preferably 0.25 or less, more preferably 0.17 or less, particularly 0.15 or less.

The contact angle of the protective film on the side having the outermost layer with respect to water is preferably 90° or more, more preferably 95° or more, particularly 100° or more.

(Saponification)

The aforementioned saponification is preferably carried out by a known method, e.g., by dipping the transparent support or the anti-reflection film in an alkaline solution for a proper period of time.

The alkaline solution is preferably an aqueous solution of potassium hydroxide and/or aqueous solution of sodium hydroxide. The alkaline solution preferably has a concentration of from 0.5 to 3 mol/l, particularly from 1 to 2 mol/l. The temperature of the alkaline solution is preferably from 30° C. to 70° C., particularly from 40° C. to 60° C.

The transparent support which has been dipped in the alkaline solution is preferably washed thoroughly with water or dipped in a diluted acid to neutralize the alkaline component so that the alkaline component doesn't remain in the film.

When saponified, the surface of the transparent support is hydrophilicized. The protective film for polarizing plate is bonded to the polarizing layer on the saponified surface of the transparent support.

The hydrophilicized surface of the transparent support is advantageous in the enhancement of the adhesivity to the polarizing layer mainly composed of polyvinyl alcohol.

The saponification is preferably effected in such a manner that the contact angle of the surface of the transparent support on the side thereof opposite the anti-glare layer or low refractive index layer with respect to water is 40° or less, more preferably 30° or less, particularly 250 or less.

(Polarizing Plate)

The polarizing plate of the invention has an anti-reflection film of the invention provided on at least one of the protective films for polarizing layer (protective film for polarizing plate). The protective film for polarizing plate preferably has a contact angle of 40° or less with respect to water on the surface of the transparent support on the side thereof opposite the outermost layer, i.e., on the side on which it is stuck to the polarizing layer.

The use of the anti-reflection film of the invention as a protective film for polarizing plate makes it possible to prepare a polarizing plate having anti-reflection properties and reduce drastically cost and thickness of display device.

Further, the constitution of a polarizing plate comprising an anti-reflection film of the invention as one of the two sheets of protective film and an optical compensation film having an optical anisotropy described later as the other makes it possible to prepare a polarizing plate that provides a liquid crystal display device with an improved contrast in the daylight and a drastically raised horizontal and vertical viewing angle to advantage.

(Optical Compensation Film)

The aforementioned optical compensation film (retarder film) can improve the viewing angle properties of a liquid crystal display screen.

As an optical compensation film there may be used any material known as such. In respect to the rise of viewing angle, there is preferably used an optical compensation film having an optically anisotropic layer made of a compound having a discotic structural unit described in JP-A-2001-100042 wherein the angle of the discotic compound with the surface of the film changes in the depth direction of the optically anisotropic layer. In some detail, the compound having a discotic structural unit is oriented in hybrid alignment, bent alignment, twist alignment, homogeneous alignment, homeotropic alignment or the like, particularly hybrid alignment. The aforementioned angle preferably changes with the rise of the distance of the optical compensation film from the surface of the support in the optically anisotropic layer.

In the case where the optical compensation film is used as a protective film for polarizing layer, the optical compensation film is preferably saponified on the side thereof on which it is stuck to the polarizing layer. The saponification is preferably effected under the aforementioned saponification conditions.

In another embodiment, the optically anisotropic layer further contains a cellulose ester. In other embodiment, an alignment layer is provided interposed between the optically anisotropic layer and the transparent support of the optical compensation film. In a further embodiment, the transparent support of the optical compensation film having the optically anisotropic layer has an optically negative uniaxiality and an optical axis is provided in the direction normal to the surface of the transparent support. In a further preferred embodiment, the following condition is satisfied.
20≦{(nx+ny)/2−nz}×d≦400
wherein nx represents the in-plane refractive index in the slow axis direction (in-plane maximum refractive index); ny represents the in-plane refractive index in the direction perpendicular to the slow axis; nz represents the refractive index in the direction perpendicular to plane; and d represents the thickness (nm) of the optically anisotropic layer.
(Image Display Device)

The anti-glare anti-reflection film can be applied to image display devices such as liquid crystal display device (LCD), plasma display panel (PDP), electroluminescence display (ELD) and cathode ray tube display device (CRT). The anti-reflection film is bonded to the image display surface of an image display device on the transparent support side thereof.

The anti-reflection film and polarizing plate to be used in the invention can be preferably used in transmission type, reflection type or semi-transmission type liquid crystal devices of modes such as twisted nematic (TN), super twisted nematic (STN), vertical alignment (VA), in-plane switching (IPS) and optically compensated bend cell. For TN mode or IPS mode liquid crystal display devices in particular, a polarizing plate comprising the aforementioned optical compensation film and anti-reflection film as protective film can be used to drastically enhance the viewing angle properties and anti-reflection properties thereof as disclosed in JP-A-2001-10043.

Further, the use of the anti-reflection film and polarizing plate in combination with a commercially available brightness enhancement film (polarization separation film having a polarization selection layer such as D-BEF (produced by Sumitomo 3M Co., Ltd.)) makes it possible to obtain a transmission type or semi-transmission type liquid crystal display device having a higher viewability.

Moreover, when combined with a λ/4 plate, the anti-reflection film and polarizing plate can be used as polarizing plate for reflection type liquid crystal or surface protective plate for organic EL display to reduce the amount of light reflected from the surface and interior thereof

### Example

The invention will be further described in the following examples, but the invention should not be construed as being limited thereto.

### Examples of Synthesis of Polymer Compounds

0.6 g of a polyvinyl alcohol was dissolved in 300 ml of water. To the solution was then added a mixture of 81.6 g of methyl methacrylate and 15.9 g of methyl acrylate having 2 g of azobisisobutyronitrile dissolved therein. The mixture was stirred by means of a disperser for 5 minutes, and then reacted with light stirring at 75° C. in a nitrogen atmosphere for 4 hours.

The reaction product was lightly dehydrated by means of a centrifugal separator, washed with water, and then dried to obtain a polymer compound K3.
(Synthesis of Perfluoroolefin Copolymer PF-1)

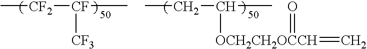

(The ratio 50:50 is by mol)

Into an autoclave with stainless steel agitator were charged 40 parts by mass of ethyl acetate, 14.7 parts by mass of hydroxyethyl vinyl ether and 0.55 parts by mass of dilauroyl peroxide. The air within the system was evacuated and replaced by nitrogen gas. 25 parts by mass of hexafluoropropylene (HFP) were introduced into the autoclave which was then heated to 65° C. When the internal temperature of the autoclave reached 65° C., the pressure in the autoclave was 5.4 kg/cm² (529 kPa). The reaction continued with the temperature kept at 65° C. for 8 hours. When the pressure in the autoclave reached 3.2 kg/cm² (314 kPa), heating was then suspended to allow the autoclave to cool. When the internal temperature of the autoclave reached room temperature, the unreacted monomers were then driven out. The autoclave was then opened to withdraw the reaction solution.

The reaction solution thus obtained was then put in a large excess of hexane. The solvent was then removed by decantation to withdraw the precipitated polymer. The polymer was dissolved in a small amount of ethyl acetate, and then reprecipitated twice from hexane to fully remove the remaining monomer. The residue was then dried to obtain 28 parts by mass of a polymer product.

Subsequently, 20 parts by mass of the polymer product was dissolved in 100 parts by mass of N,N-dimethylacetamide. To the solution thus obtained were added dropwise 11.4 parts by mass of acrylic acid chloride. The mixture was then stirred at room temperature for 10 hours. To the reaction mixture was added ethyl acetate. The reaction mixture was then washed with water. The resulting organic phase was extracted, and then concentrated. The polymer thus obtained was reprecipitated from hexane to obtain 19 parts by mass of the aforementioned perfluoroolefin copolymer PF-1. The perfluoroolefin copolymer thus obtained showed a refractive index of 1.421.

The aforementioned perfluoroolefin copolymer PF-1 was then dissolved in methyl ethyl ketone to obtain a solution having a solid content concentration of 30%.

(Preparation of Solution of Organosilane Compound A)

Into a reaction vessel equipped with an agitator and a reflux condenser were charged 120 parts by mass of methyl ethyl ketone, 100 parts by mass of 3-acryloxypropyl trimethoxysilane (KBM-5103, produced by Shin-Etsu Chemical Co., Ltd.) and 3 parts by mass of diisopropoxy aluminum ethyl acetoacetate. These components were then stirred. To the mixture were then added 30 parts of deionized water. The reaction mixture was then reacted at 60° C. for 4 hours. The reaction mixture was then allowed to cool to room temperature to obtain a solution of an organosilane compound A. The weight-average molecular weight of the organosilane compound thus obtained was 1,600. The proportion of the components having a weight-average molecular weight of from 1,000 to 20,000 in the oligomer components and higher components was 100%. The gas chromatography of the reaction product showed that none of the 3-acryloyloxy propyl trimethoxysilane as raw material remained.

(Preparation of Anti-Glare Layer Coating Compound B-1)

To 47.0 parts by mass of a mixture of pentaerythritol triacrylate and pentaerythritol tetraacrylate (KAYARAD PET-30, produced by Nippon Kayaku Corporation) were added 2.0 parts by mass of a polymerization initiator (Irgacure 184, produced by Ciba Specialty Chemicals Co., Ltd.), 0.75 parts by mass of a fluorine-based surface condition improver (FP-7-12), 10.0 parts by mass of an organosilane compound (KBM-5103, produced by Shin-Etsu Chemical Co., Ltd.), 16.0 parts by mass of a 30% toluene solution of a polymer compound K3 and 22.5 parts by mass of toluene. These components were then stirred. The solution was then spread, and then cured by irradiation with ultraviolet rays to obtain a coat layer having a refractive index of 1.51.

To the solution were then added 12.6 parts by mass of a 30% toluene dispersion of a particulate crosslinked polystyrene having an average particle diameter of 3.5 μm (refractive index: 1.60; SX-350, produced by Soken Chemical & Engineering Co., Ltd.) which had been dispersed at 10,000 rpm by a polytron disperser and 10.0 parts by mass of a 30% toluene dispersion of a particulate crosslinked acryl-styrene having an average particle diameter of 3.5 μm (refractive index: 1.55; produced by Soken Chemical & Engineering Co., Ltd.) which had been dispersed at 10,000 rpm by a polytron disperser. The mixture was then stirred.

The mixture was then filtered through a polypropylene filter having a pore diameter of 30 μm to prepare an anti-glare layer coating compound B-1. The coat layer made of the coating compound exhibited a refractive index of 1.51.

The anti-glare layer coating compound B-1 exhibited a viscosity of 9.8 mPa·s and a surface tension of 27 mN/m.

The comparative coating compound BR-3, which is free of polymer solution, described layer exhibited a viscosity of 4.7 mPa·s and showed a viscosity rise of 5.1 mPa·s when provided with a polymer solution.

(Preparation of Anti-Glare Layer Coating Compound B-2)

An anti-glare layer coating compound B-2 was prepared in the same manner as the anti-glare layer coating compound B-1 except that as the polymer compound there was used K1. The coating compound thus obtained exhibited a viscosity of 8.0 mPa·s.

(Preparation of Anti-Glare Layer Coating Compound B-3)

An anti-glare layer coating compound B-3 was prepared in the same manner as the anti-glare layer coating compound B-1 except that as the polymer compound there was used K4. The coating compound thus obtained exhibited a viscosity of 14.6 mPa·s.

(Preparation of Anti-Glare Layer Coating Compound B-4)

An anti-glare layer coating compound B-4 was prepared in the same manner as the anti-glare layer coating compound B-1 except that as the polymer compound there was used a poly(methyl methacrylate/ethyl acrylate) copolymer (molecular weight: 101,000, produced by SIGMA-ALDRICH Japan KK). The coating compound thus obtained exhibited a viscosity of 9.2 mPa·s.

(Preparation of Anti-Glare Layer Coating Compound B-5)

An anti-glare layer coating compound B-5 was prepared in the same manner as the anti-glare layer coating compound B-1 except that as the polymer compound there was used a poly(methyl methacrylate/butyl methacrylate) copolymer (molecular weight: 75,000, produced by SIGMA-ALDRICH Japan KK). The coating compound thus obtained exhibited a viscosity of 8.9 mPa·s.

(Preparation of Anti-Glare Layer Coating Compound B-6)

An anti-glare layer coating compound B-6 was prepared in the same manner as the anti-glare layer coating compound B-1 except that as the polymer compound there was used an isobutyl polymethacrylate (molecular weight: 300,000, produced by KANTO CHEMICAL CO., INC.). The coating compound thus obtained exhibited a viscosity of 11.7 mPa·s.

(Preparation of Anti-Glare Layer Coating Compound B-7)

An anti-glare layer coating compound B-7 was prepared in the same manner as the anti-glare layer coating compound B-1 except that as the polymer compound there was used a methyl polymethacrylate (molecular weight: 120,000, produced by SIGMA-ALDRICH Japan KK). The coating compound thus obtained exhibited a viscosity of 9.5 mPa·s.

(Preparation of Anti-Glare Layer Coating Compound B-8)

An anti-glare layer coating compound B-8 was prepared in the same manner as the anti-glare layer coating compound B-1 except that as the polymer compound there was used Sumipex LG21 (produced by Sumitomo Chemical Co., Ltd.). The coating compound thus obtained exhibited a viscosity of 9.8 mPa·s.

(Preparation of Anti-Glare Layer Coating Compound B-9)

An anti-glare layer coating compound B-9 was prepared in the same manner as the anti-glare layer coating compound B-1 except that as the polymer compound there was used Sumipex LG (produced by Sumitomo Chemical Co., Ltd.). The coating compound thus obtained exhibited a viscosity of 10.1 mPa·s.

(Preparation of Anti-Glare Layer Coating Compound B-10)

An anti-glare layer coating compound B-10 was prepared in the same manner as the anti-glare layer coating compound B-1 except that as the polymer compound there was used Acrypet MD (produced by Mitsubishi Rayon Co., Ltd.). The coating compound thus obtained exhibited a viscosity of 10.3 mPa·s.

(Preparation of Anti-Glare Layer Coating Compound B-11)

An anti-glare layer coating compound B-11 was prepared in the same manner as the anti-glare layer coating compound B-1 except that 16.0 parts by mass of 30% toluene solution of polymer compound K3 was added at the last step in the order of addition of reagents. The coating compound exhibited a viscosity of 4.7 mPa·s before the addition of the polymer compound K3. The coating compound which had comprised the polymer compound solution incorporated therein and then been stirred exhibited a viscosity of 9.8 mPa·s.

(Preparation of Anti-Glare Layer Coating Compound B-12)

An anti-glare layer coating compound B-12 was prepared in the same manner as the anti-glare layer coating compound B-1 except that 16.0 parts by mass of a 30% toluene solution of polymer compound K3 for anti-glare layer coating compound B-1 was replaced by 7.0 parts by mass of a 10% methyl isobutyl ketone solution of cellulose acetate butyrate (weight-average molecular weight: about 260,000; produced by Eastman Chemical Co., Ltd.) and the amount of toluene to be added subsequently was changed to 31.5 parts by mass. The coating compound thus obtained exhibited a viscosity of 10.2 mPa·s.

(Preparation of Anti-Glare Layer Coating Compound B-13)

An anti-glare layer coating compound B-13 was prepared in the same manner as the anti-glare layer coating compound B-1 except that 16.0 parts by mass of a 30% toluene solution of polymer compound K3 for anti-glare layer coating compound B-1 was replaced by 5.6 parts by mass of a 10% methyl isobutyl ketone solution of a polyvinyl acetate (weight-average molecular weight: 500,000; produced by SIGMA-ALDRICH Japan KK) and the amount of toluene to be added subsequently was changed to 32.9 parts by mass. The coating compound thus obtained exhibited a viscosity of 9.5 mPa·s.

(Preparation of Comparative Anti-Glare Layer Coating Compound BR-1)

A comparative anti-glare layer coating compound BR-1 was prepared in the same manner as the anti-glare layer coating compound B-1 except that no polymer compound was added and 16.0 parts by mass of toluene was added instead. The coating compound thus obtained exhibited a viscosity of 4.2 mPa·s.

(Preparation of Comparative Anti-Glare Layer Coating Compound BR-2)

A comparative anti-glare layer coating compound BR-2 was prepared in the same manner as the anti-glare layer coating compound B-1 except that as the polymer compound there was used a poly(methyl methacrylate/methyl acrylate)(90/10; molecular weight: 950,000). The coating compound thus obtained exhibited a viscosity of 19.6 mPa·s.

(Preparation of Comparative Anti-Glare Layer Coating Compound BR-3)

A coating compound was prepared in the same manner as the anti-glare layer coating compound B-11 except that 30% toluene solution of polymer compound K3 was not added. The coating compound thus obtained exhibited a viscosity of 4.7 mPa·s.

(Anti-Reflection Layer Coating Compound AS-1)

A commercially available transparent antistatic layer coating compound “Peltron C-4456S-7” (solid content concentration: 45%; produced by Nippon Pelnox Corporation) was used as an antistatic layer coating compound A. Peltron C-4456S-7 is a transparent antistatic layer coating compound comprising an electrically-conductive particulate material ATO dispersed therein with a dispersant. The coat layer formed by the coating compound exhibited a refractive index of 1.55.

(Preparation of Low Refractive Index Layer Coating Compound L-1)

To 13.0 parts by mass of a heat-crosslinkable fluorine-containing polymer having a refractive index of 1.42 (JN7228A; solid content concentration: 6%; produced by JSR Co., oLtd.) were added 1.3 parts by mass of an MEK dispersion of particulate silica (MEK-ST-L; average particle diameter: 45 nm; solid content concentration: 30%; produced by NISSAN CHEMICAL INDUSTRIES, LTD.), 0.6 parts by mass of the aforementioned organosilane compound A solution, 5.0 parts by mass of methyl ethyl ketone and 0.6 parts by mass of cyclohexanone. The mixture was then stirred. The mixture was then filtered through a polypropylene filter having a pore diameter of 1 μm to prepare a low refractive index layer coating compound L-1. The coat layer made of the coating compound exhibited a refractive index of 1.42.

(Preparation of Low Refractive Index Layer Coating Compound L-2)

To 15.0 parts by mass of a heat-crosslinkable fluorine-containing polymer having a refractive index of 1.42 (JN7228A; solid content concentration: 6%; produced by JSR Co., Ltd.) were added 0.6 parts by mass of an MEK dispersion of particulate silica (MEK-ST; average particle diameter: 15 nm; solid content concentration: 30%; produced by NISSAN CHEMICAL INDUSTRIES, LTD.), 0.8 parts by mass of an MEK dispersion of particulate silica (MEK-ST-L; average particle diameter: 45 nm; solid content concentration: 30%; produced by NISSAN CHEMICAL INDUSTRIES, LTD.), 0.4 parts by mass of the aforementioned organosilane compound A solution, 3.0 parts by mass of methyl ethyl ketone and 0.6 parts by mass of cyclohexanone. The mixture was then stirred. The mixture was then filtered through a polypropylene filter having a pore diameter of 1 μm to prepare a low refractive index layer coating compound L-2. The coat layer made of the coating compound exhibited a refractive index of 1.42.

(Preparation of MEK Dispersion of Hollow Particulate Silica)

To 500 parts of a hollow particulate silica sol (isopropyl alcohol silica sol; produced by CATALYSTS&CHEMICALS IND. CO., LTD.; average particle diameter: 60 nm; shell thickness: 10 nm; silica concentration: 20 wt-%; refractive index of particulate silica: 1.31; prepared by changing the particle size according to Preparation Example 4 in JP-A-2002-79616) were added 30 parts by mass of acryloyloxypropyl trimethoxysilane (produced by Shin-Etsu Chemical Co., Ltd.) and 1.5 parts by mass of diisopropoxy aluminum ethyl acetate (Chlope EP-12, produced by Hope Chemical Co., Ltd.). The mixture was then stirred. To the mixture were then added 9 parts by mass of deionized water. The mixture was reacted at 60° C. for 8 hours, and then allowed to cool to room temperature. To the reaction product were then added 1.8 parts by mass of acetyl acetone. 500 g of the dispersion was then subjected to solvent replacement by reduced pressure distillation at 20 kPa while methyl ethyl ketone was being added in such an amount that the silica content was kept constant. As a result, no foreign matters were produced in the dispersion. The dispersion the solid content concentration of which had been adjusted to 20% by mass with methyl ethyl ketone exhibited a viscosity of 5 mPa·s at 25° C. The dispersion A-1 thus obtained was then analyzed for isopropyl alcohol residue by gas chromatography. The result was 1.5%.

(Preparation of Low Refractive Index Layer Coating Compound L-3)

To 13.0 parts by mass of a heat-crosslinkable fluorine-containing polymer having a refractive index of 1.42 (JN7228A; solid content concentration: 6%; produced by JSR Co., Ltd.) were added 1.95 parts by mass of an MEK dispersion of particulate silica (refractive index: 1.31; average particle diameter: 60 nm; solid content concentration: 20%), 0.6 parts by mass of the aforementioned organosilane compound A solution, 4.35 parts by mass of methyl ethyl ketone and 0.6 parts by mass of cyclohexanone. The mixture was then stirred. The mixture was then filtered through a polypropylene filter having a pore diameter of 1 μm to prepare a low refractive index layer coating compound L-3. The coat layer made of the coating compound exhibited a refractive index of 1.40.

(Preparation of Low Refractive Index Layer Coating Compound L-4)

To a 1/1 (by mass) mixture of isopropyl alcohol and methyl ethyl ketone were added 1 mol of tetramethoxysilane and 2 mols of a 0.1 mol/l hydrochloric acid. The mixture was then allowed to undergo hydrolyzation reaction with stirring at room temperature for 2 hours to prepare a solution of hydrolyzate of tetramethoxysilane.

To a 1/1 (by mass) mixture of isopropyl alcohol and methyl ethyl ketone were then added 9.0 parts by mass of hydrolyzate of tetramethoxysilane, 1.0 parts by mass of pentaerythritol triacrylate and 0.5 parts by mass of a polymerization initiator (Irgacure 907, produced by Ciba Specialty Chemicals Co., Ltd.) in such an amount that the solid content concentration reached 4.5 parts by mass. The mixture was then stirred. The mixture was then filtered through a polypropylene filter having a pore diameter of 1 μm to prepare a low refractive index layer coating compound L-4. The coat layer made of the coating compound exhibited a refractive index of 1.45.

(Preparation of Low Refractive Index Layer Coating Compound L-5)

To 15.0 parts by mass of a solution of the aforementioned perfluoroolefin copolymer PF-1 (solid content concentration: 30%) were added 0.15 parts by mass of a polysiloxane compound having an acryloyl group (X-22-164C; produced by Shin-Etsu Chemical Co., Ltd.), 0.23 parts by mass of a photopolymerization initiator (Irgacure 907, produced by Ciba Specialty Chemicals Co., Ltd.), 81.8 parts by mass of methyl ethyl ketone and 2.8 parts by mass of cyclohexanone. The mixture was then stirred. The mixture was then filtered through a polypropylene filter having a pore diameter of 1 μm to prepare a low refractive index layer coating compound L-5. The coat layer made of the coating compound exhibited a refractive index of 1.43.

(Preparation of Low Refractive Index Layer Coating Compound L-6)

To 10.5 parts by mass of a solution of the aforementioned perfluoroolefin copolymer PF-1 (solid content concentration: 30%) were added 4.5 parts by mass of an MEK dispersion of particulate silica (MEK-ST-L; average particle diameter: 45 nm; solid content concentration: 30%; produced by NISSAN CHEMICAL INDUSTRIES, LTD.), 0.15 parts by mass of a polysiloxane compound having an acryloyl group (X-22-164C; produced by Shin-Etsu Chemical Co., Ltd.), 0.23 parts by mass of a photopolymerization initiator (Irgacure 907, produced by Ciba Specialty Chemicals Co., Ltd.), 2.0 parts by mass of the aforementioned organosilane compound A solution, 81.2 parts by mass of methyl ethyl ketone and 2.8 parts by mass of cyclohexanone. The mixture was then stirred. The mixture was then filtered through a polypropylene filter having a pore diameter of 1 μm to prepare a low refractive index layer coating compound L-6. The coat layer made of the coating compound exhibited a refractive index of 1.44.

(Preparation of Low Refractive Index Layer Coating Compound L-7)

To 10.5 parts by mass of a solution of the aforementioned perfluoroolefin copolymer PF-1 (solid content concentration: 30%) were added 6.75 parts by mass of an MEK dispersion of hollow particulate silica (refractive index: 1.31; average particle diameter: 60 nm; solid content concentration: 20%), 0.15 parts by mass of a polysiloxane compound having an acryloyl group (X-22-164C; produced by Shin-Etsu Chemical Co., Ltd.), 0.23 parts by mass of a photopolymerization initiator (Irgacure 907, produced by Ciba Specialty Chemicals Co., Ltd.), 2.0 parts by mass of the aforementioned organosilane compound A solution, 81.2 parts by mass of methyl ethyl ketone and 2.8 parts by mass of cyclohexanone. The mixture was then stirred. The mixture was then filtered through a polypropylene filter having a pore diameter of 1 μm to prepare a low refractive index layer coating compound L-7. The coat layer made of the coating compound exhibited a refractive index of 1.41.

(Preparation of Low Refractive Index Layer Coating Compound L-8)

To 13.5 parts by mass of a solution of the aforementioned perfluoroolefin copolymer PF-1 (solid content concentration: 30%) were added 0.45 parts by mass of a mixture of dipentaerythritol pentaacrtylate and dipentaerythritol hexaacrylate (DPHA, produced by Nippon Kayaku Corporation), 0.15 parts by mass of a polysiloxane compound having an acryloyl group (X-22-164C; produced by Shin-Etsu Chemical Co., Ltd.), 0.23 parts by mass of a photopolymerization initiator (Irgacure 907, produced by Ciba Specialty Chemicals Co., Ltd.), 81.2 parts by mass of methyl ethyl ketone and 2.8 parts by mass of cyclohexanone. The mixture was then stirred. The mixture was then filtered through a polypropylene filter having a pore diameter of 1 μm to prepare a low refractive index layer coating compound L-8. The coat layer made of the coating compound exhibited a refractive index of 1.44.

### Example 1

The antistatic layer coating compound (AS-1) was spread over a triacetyl cellulose film having a thickness of 80 μm and a width of 1,340 mm (TAC-TD80U, produced by Fuji Photo Film Co., Ltd.) at a conveying speed of 25 m/min by a slot die coating method.

The coat layer was dried at 100° C. for 150 seconds, and then irradiated with ultraviolet rays at an illuminance of 400 mW/cm² and a dose of 500 mJ/cm² using a 240 W/cm air-cooled metal halide lamp (produced by EYE GRAPHICS CO., LTD.) while the air in the system was being purged with nitrogen such that the oxygen concentration of the atmosphere reached 0.5% or less to cure the coat layer and prepare a film having an antistatic layer.

The anti-glare layer coating compounds (B-1 to B-11) and the comparative anti-glare layer coating compounds (BR-1 to BR-3) were each spread over a triacetyl cellulose film having a thickness of 80 μm and a width of 1,340 mm (TAC-TD80U, produced by Fuji Photo Film Co., Ltd.) or the antistatic layer prepared above at a conveying speed of 25 m/min by a slot die coating method.

The coat layer was dried at 60° C. for 150 seconds, and then irradiated with ultraviolet rays at an illuminance of 400 mW/cm² and a dose of 250 mJ/cm² using a 160 W/cm air-cooled metal halide lamp (produced by EYE GRAPHICS CO., LTD.) while the air in the system was being purged with nitrogen such that the oxygen concentration of the atmosphere reached 0.5% or less to cure the coat layer and prepare a film having an antistatic layer.

The low refractive index layer coating compounds (L-1 to L-8) were each spread over the aforementioned anti-glare layer at a conveying speed of 25 m/min by a slot die coating method.

Thereafter, the low refractive index layer coating compounds (L-1 to L-3) thus spread were each dried and cured under the following conditions.

The coat layer was dried at 120° C. for 150 seconds, dried at 140° C. for 8 minutes, and then irradiated with ultraviolet rays at an illuminance of 400 mW/cm² and a dose of 900 mJ/cm² using a 240 W/cm air-cooled metal halide lamp (produced by EYE GRAPHICS CO., LTD.) while the air in the system was being purged with nitrogen such that the oxygen concentration of the atmosphere reached 0.5% or less to cure the coat layer and prepare a low refractive index layer (outermost layer).

The low refractive index layer coating compound L-4 thus spread were each dried and cured under the following conditions.

The coat layer was dried at 120° C. for 150 seconds, and then heat-treated at 140° C. for 20 minutes so that the coat layer was cured to form a low refractive index layer (outermost layer).

The low refractive index layer coating compounds (L-5 to L-8) thus spread were each dried and cured under the following conditions.

The coat layer was dried at 90° C. for 30 seconds, and then irradiated with ultraviolet rays at an illuminance of 600 mW/cm² and a dose of 600 mJ/cm² using a 240 W/cm air-cooled metal halide lamp (produced by EYE GRAPHICS CO., LTD.) while the air in the system was being purged with nitrogen such that the oxygen concentration of the atmosphere reached 0.5% or less to cure the coat layer and prepare a low refractive index layer (outermost layer).

The spreading of the aforementioned antistatic layer coating compound, anti-glare layer coating compound and low refractive index layer coating compound in the anti-reflection film according to the invention were effected in combination as set forth in Table 1.

TABLE 1

| | Constitution and thickness of coat layer and viscosity of coating compound | | | | | | |
|---|---|---|---|---|---|---|---|
| | | | | | | Low refractive | |
| | Antistatic layer | | Anti-glare layer | | | index layer | |
| | Coating | Thickness | Coating | Viscosity | Thickness | Coating | Thickness |
| Sample No. | compound | (μm) | compound | (mPa · s) | (μm) | compound | (μm) |
| 101 (inventive) | AS-1 | 4.5 | B-1 | 9.8 | 6.4 | L-1 | 0.1 |
| 102 (inventive) | AS-1 | 4.5 | B-2 | 8.0 | 6.4 | L-1 | 0.1 |
| 103 (inventive) | None | None | B-1 | 9.8 | 6.4 | L-1 | 0.1 |
| 104 (inventive) | None | None | B-2 | 8.0 | 6.4 | L-1 | 0.1 |
| 105 (inventive) | None | None | B-3 | 14.6 | 6.4 | L-1 | 0.1 |
| 106 (inventive) | None | None | B-4 | 9.2 | 6.4 | L-1 | 0.1 |
| 107 (inventive) | None | None | B-5 | 8.9 | 6.4 | L-1 | 0.1 |
| 108 (inventive) | None | None | B-6 | 11.7 | 6.4 | L-1 | 0.1 |
| 109 (inventive) | None | None | B-7 | 9.5 | 6.4 | L-1 | 0.1 |
| 110 (inventive) | None | None | B-8 | 9.8 | 6.4 | L-1 | 0.1 |
| 111 (inventive) | None | None | B-9 | 10.1 | 6.4 | L-1 | 0.1 |
| 112 (inventive) | None | None | B-10 | 10.3 | 6.4 | L-1 | 0.1 |
| 113 (inventive) | None | None | B-11 | 9.8 | 6.4 | L-1 | 0.1 |
| 114 (inventive) | None | None | B-12 | 10.2 | 6.4 | L-1 | 0.1 |
| 115 (inventive) | None | None | B-13 | 9.5 | 6.4 | L-1 | 0.1 |
| 116 (inventive) | None | None | B-1 | 9.8 | 6.4 | L-2 | 0.1 |
| 117 (inventive) | None | None | B-1 | 9.8 | 6.4 | L-3 | 0.1 |
| 118 (inventive) | None | None | B-1 | 9.8 | 6.4 | L-4 | 0.1 |
| 119 (inventive) | None | None | B-1 | 9.8 | 6.4 | L-5 | 0.1 |
| 120 (inventive) | None | None | B-1 | 9.8 | 6.4 | L-6 | 0.1 |
| 121 (inventive) | None | None | B-1 | 9.8 | 6.4 | L-7 | 0.1 |
| 122 (inventive) | None | None | B-1 | 9.8 | 6.4 | L-8 | 0.1 |
| 123 (comparative) | None | None | BR-1 | 4.2 | 6.1 | L-1 | 0.1 |
| 124 (comparative) | None | None | BR-2 | 19.6 | 6.4 | L-1 | 0.1 |
| 125 (comparative) | None | None | BR-3 | 4.7 | 6.2 | L-1 | 0.1 |

Thickness: value measured after drying, irradiation with ultraviolet rays or heating

(Evaluation of Anti-Reflection Film)

The anti-reflection film samples thus obtained were each evaluated for the following properties. The results are set forth in Table 2.

(1) Evaluation of Surface Resistivity

The anti-reflection film was measured for surface resistivity on the surface having a low refractive index layer (outermost layer) at 25° C. and a relative humidity of 60% using a super megaohm/microcurrent meter TR8601 (produced by ADVANTEST CORPORATION)

(2) Evaluation of Dustability

The anti-reflection film was stuck to a monitor. A dust (flocks of mat, cloth) was then sprayed onto the surface of the monitor. The dust was then wiped off the surface of the monitor with a cleaning cloth to examine dustability. The results were then evaluated according to the following three-step criterion.

G (good): Dust completely removed

F (fair): Dust remains somewhat (tolerable)

P (poor): Much dust remains

(3) Evaluation of Anti-Glare Properties

Light rays from an uncovered fluorescent lamp (8,000 cd/cm²) without louver were reflected by the anti-reflection film. The resulting reflected image was then evaluated for blur according to the following criterion.

E (excellent): The contour of the fluorescent lamp is little perceived;

G (good): The contour of the fluorescent lamp is somewhat perceived;

F (fair): The periphery of the fluorescent lamp looks whitish, but the contour of the fluorescent lamp can be perceived (tolerable);

P₍₁₎: The image of the fluorescent lamp is little blurred;

P₍₂₎: The contour of the fluorescent lamp is not perceived and the fluorescent lamp generally looks much whitish.

(4) Evaluation of Average Reflectance

Using a spectrophotometer (V-550, produced by JASCO) and an integrating sphere, the anti-reflection film sample was measured for spectral reflectance at an incidence angle of 5° within a wavelength range of from 380 nm to 780 nm. For the evaluation of spectral reflectance, the average reflectance at a wavelength of from 450 nm to 650 nm was used.

(5) Evaluation of Coat Surface Conditions

The anti-reflection film sample was cut into a size of the total coat width and a length of 30 cm in the spreading direction. The specimen was then put on a black cloth with the coat layer side thereof facing upward. The surface of the specimen was then visually observed under an incandescent lamp. The results were evaluated according to the following criterion.

E (excellent): No streak-like coating unevenness in the coating direction observed;

G (good): Extremely light streak-like coating unevenness observed at some points when carefully checked;

F (fair): Light streak-like coating unevenness observed at some points;

FP (fair-poor): Light streak-like coating unevenness observed throughout the entire width;

P: Heavy streak-like coating unevenness observed throughout the entire width

TABLE 2

| | Surface resistivity | | Anti-glare | % | Coat surface |
|---|---|---|---|---|---|
| Sample No. | (Ω/sq.) | Dustability | properties | Reflectance | conditions |
| 101(inventive) | 1.2 × 10⁸ | G | E | 2.4 | E |
| 102(inventive) | 1.5 × 10⁸ | G | E | 2.4 | E |
| 103(inventive) | 1.9 × 10¹⁴ | F | E | 2.4 | E |
| 104(inventive) | 2.1 × 10¹⁴ | F | E | 2.4 | E |
| 105(inventive) | 2.0 × 10¹⁴ | F | E | 2.4 | G |
| 106(inventive) | 1.7 × 10¹⁴ | F | E | 2.4 | E |
| 107(inventive) | 1.5 × 10¹⁴ | F | E | 2.4 | E |
| 108(inventive) | 2.3 × 10¹⁴ | F | E | 2.4 | E |
| 109(inventive) | 2.5 × 10¹⁴ | F | G | 2.4 | E |
| 110(inventive) | 3.2 × 10¹⁴ | F | E | 2.4 | E |
| 111(inventive) | 2.2 × 10¹⁴ | F | E | 2.4 | E |
| 112(inventive) | 2.3 × 10¹⁴ | F | E | 2.5 | E |
| 113(inventive) | 1.9 × 10¹⁴ | F | E | 2.4 | E |
| 114(inventive) | 4.1 × 10¹⁴ | F | E | 2.4 | E |
| 115(inventive) | 5.0 × 10¹⁴ | F | E | 2.4 | E |
| 116(inventive) | 3.5 × 10¹⁴ | F | E | 2.4 | E |
| 117(inventive) | 1.5 × 10¹⁴ | F | E | 2.1 | E |
| 118(inventive) | 2.3 × 10¹⁴ | F | E | 2.5 | E |
| 119(inventive) | 2.0 × 10¹⁴ | F | E | 2.4 | E |
| 120(inventive) | 2.3 × 10¹⁴ | F | E | 2.3 | E |
| 121(inventive) | 2.5 × 10¹⁴ | F | E | 2.1 | E |
| 122(inventive) | 1.5 × 10¹⁴ | F | E | 2.5 | E |
| 123(comparative) | 2.0 × 10¹⁴ | F | P₍₂₎ | 2.7 | E |
| 124(comparative) | 2.1 × 10¹⁴ | F | F | 2.1 | P |
| 125(comparative) | 2.0 × 10¹⁴ | F | P₍₂₎ | 2.7 | E |

As can be seen in the results of Tables 1 and 2, as compared with the comparative anti-reflection films (Sample Nos. 123 and 125), which are free of polymer compound, the inventive compositions (Nos. 101 to 122), made of coating compositions having a predetermined viscosity rise attained by the incorporation of a polymer compound, can prevent themselves from looking generally whitish due to excessive anti-glare properties and thus exhibit proper anti-glare properties. Further, the comparative anti-reflection film sample (Sample No. 124), made of a coating composition the viscosity of which is raised more than necessary, reflects the contour of the fluorescent lamp and thus exhibits insufficient anti-glare properties and poor coat surface conditions. It is obvious that the invention provides excellent results on the anti-glare properties and the coat surface conditions, etc.

### Example 2

(Evaluation of Image Display Device)

The anti-reflection film samples 101 to 122 of Example 1 were each attached to the display surface of image display devices (TN, STN, IPS, VA or OCB mode transmission type, reflection type or semi-transmission type liquid crystal display devices, plasma display panel (PDP), electroluminescence display (ELD), cathode ray tube display device (CRT)). The image display devices comprising the inventive anti-reflection films were excellent in anti-reflection properties, dustproofness, scratch resistance and stainproofness.

The inventive anti-reflection films also showed no unevenness having a section area of 100 μm² or more and hence no glittering in image display devices having a pixel size of 100 ppi (100 pixels/inch: 100 pixels per inch square).

### Example 3

(Preparation of Protective Film for Polarizing Plate)

A 1.5 mol/l aqueous solution of sodium hydroxide was kept at 50° C. to prepare a saponifying solution. Further, a 0.01 mol/l diluted aqueous solution of sulfuric acid was prepared.

The anti-reflection film samples 101 to 122 of Example 1 were each subjected to saponification with the aforementioned saponifying solution on the surface of the transparent support on the side thereof opposite the low refractive index layer (outermost layer).

The saponified surface of the transparent support was thoroughly washed with water to remove the aqueous solution of sodium hydroxide, washed with the aforementioned diluted aqueous solution of sulfuric acid, thoroughly washed with water to remove the diluted aqueous solution of sulfuric acid, and then thoroughly dried at 100° C.

The anti-reflection film was then evaluated for contact angle with respect to water on the saponified surface of the transparent support on the side thereof opposite the low refractive index layer (outermost layer). The result was 40° or less. Thus, a protective film for polarizing plate was prepared.

(Preparation of Polarizing Plate)

The anti-reflection film of the invention (protective film for polarizing plate) was stuck to one surface of the polarizing layer described in JP-A-2002-86554 on the saponified triacetyl cellulose side thereof with a 3% aqueous solution of PVA (PVA-117H, produced by KURARAY CO., LTD.) as an adhesive. A triacetyl cellulose film (Fujitac; retardation: 3.0 nm; produced by Fuji Photo Film Co., Ltd.) which had been saponified in the same manner as mentioned above was stuck to the other side of the polarizing layer with the same adhesive as used above. Thus, a polarizing plate of the invention was prepared.

(Evaluation of Image Display Device)

The transmission type, reflection type or semi-transmission type image display devices of TN, STN, IPS, VA and OCB modes comprising the inventive polarizing plates were excellent in anti-reflection properties, dustproofness, scratch resistance and stainproofness. Polarizing plates prepared from various known polarizing layers in the same manner as mentioned above, too, gave similar results.

### Example 4

(Preparation of Polarizing Plate)

An optical compensation film (Wide View Film SA 12B, produced by Fuji Photo Film Co., Ltd.) was subjected to saponification on the side thereof opposite the optically anisotropic layer under the same conditions as in Example 3.

(Evaluation of Image Display Device)

The transmission type, reflection type or semi-transmission type image display devices of TN, STN, IPS, VA and OCB modes comprising the inventive polarizing plates thus prepared exhibited a higher contrast in the daylight and wider horizontal and vertical viewing angles than liquid crystal display devices comprising a polarizing plate free of optical compensation film and were excellent in anti-reflection properties, dustproofness, scratch resistance and stainproofness. In particular, the particulate crosslinked polystyrene, particulate crosslinked acryl-polystyrene, particulate crosslinked PMMA and particulate silica exerted an effect of scattering transmitted light to remarkably widen the downward viewing angle and improve the horizontal yellowish tint.

Polarizing plates prepared from various known polarizing layers in the same manner as mentioned above, too, gave similar results.

### Example 5

(Evaluation of Image Display Device)

Organic EL display devices comprising the anti-reflection film samples 101 to 122 of Example 1 were excellent in anti-reflection properties, dustproofness, scratch resistance and stainproofness.

A polarizing plate comprising the protective film for polarizing plate prepared in Example 3 provided on one side of a polarizing layer and a λ/4 plate provided on the other was prepared in the same manner as in Example 3. The polarizing plate thus obtained was then attached to an organic EL display device. As a result, a display device which can prevent the reflection of light rays from the surface of glass to which the polarizing plate is stuck and thus exhibits an extremely high viewability was obtained.

The anti-reflection film of the invention exhibits excellent anti-glare properties and good coat surface conditions and can be stably provided. The polarizing plate and image display device of the invention comprise the aforementioned anti-reflection film and thus can provide a high quality image with an excellent viewability.

The entire disclosure of each and every foreign patent application from which the benefit of foreign priority has been claimed in the present application is incorporated herein by reference, as if fully set forth.

What is claimed is:

1. An anti-glare anti-reflection film comprising an anti-glare layer and at least one low refractive index layer provided on or above a transparent support,
wherein the anti-glare layer is a layer formed by spreading a coating composition for anti-glare layer, the coating composition for anti-glare layer to be spread comprises a polymer compound and the coating composition for anti-glare layer shows a viscosity rise of 3 mPa·s to 10 mPa·s due to the incorporation of the polymer compound.

2. The anti-glare anti-reflection film as defined in claim 1,
wherein the anti-glare layer is formed by spreading a coating composition for anti-glare layer having a viscosity of from 6 mPa·s to 20 mPa·s comprising a polymer compound.

3. The anti-glare anti-reflection film as defined in claim 1,
wherein the polymer compound has a weight-average molecular weight of from 5,000 to 600,000.

4. The anti-glare anti-reflection film as defined in claim 1,
wherein the polymer compound has a weight-average molecular weight of from 5,000 to 200,000.

5. The anti-glare anti-reflection film as defined in claim 1,
wherein the polymer compound is a copolymer.

6. The anti-glare anti-reflection film as defined in claim 1,
wherein the polymer compound is incorporated in an amount of from 5% to 30% by mass based on the total weight of binders incorporated in the anti-glare layer.

7. The anti-glare anti-reflection film as defined in claim 1,
wherein the polymer compound is a (meth)acrylic resin.

8. The anti-glare anti-reflection film as defined in claim 1,
wherein the polymer compound is a cellulose ester-based resin.

9. The anti-glare anti-reflection film as defined in claim 1,
wherein the polymer compound is a vinyl-based resin.

10. The anti-glare anti-reflection film as defined in claim 1,
wherein the anti-glare layer comprises a light-transmitting particulate material having a particle diameter of from 1 μm to 8 μm,
a refractive index of a binder matrix in the anti-glare layer is from 1.45 to 1.90, and
the difference in refractive index between the binder matrix and the light-transmitting particulate material in the anti-glare layer is from 0.02 to 0.30.

11. The anti-glare anti-reflection film as defined in claim 1,
wherein the anti-glare layer comprises a light-transmitting particulate material having a particle diameter of from 1 μm to 8 μm,
a thickness of the anti-glare layer is from 3 μm to 10 μm, and
an average particle diameter of the light-transmitting particulate material in the anti-glare layer falls within a range of from 30% to 80% of the thickness of the anti-glare layer.

12. The anti-glare anti-reflection film as defined in claim 1,
wherein at least one of layers on or above the transparent support comprises at least one of organosilane compounds represented by general formula (a) and derivatives thereof:
(R¹⁰)_{S}—Si(Z)_{4-S} (a)
wherein R¹⁰ represents a substituted or unsubstituted alkyl or aryl group; Z represents a hydroxyl group or hydrolyzable group; and s represents an integer of from 1 to 3.

13. The anti-glare anti-reflection film as defined in claim 1,
wherein the low refractive index layer is formed by crosslinking or polymerization reaction of a fluorine-containing compound represented by general formula (1): 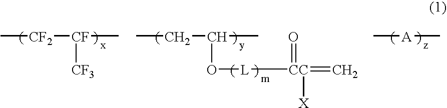
wherein L represents a connecting group having from 1 to 10 carbon atoms; m represents 0 or 1; X represents a hydrogen atom or methyl group; A represents an arbitrary vinyl monomer polymerizing unit which may be a single polymerizing unit or may comprises a plurality of polymerizing units; and x, y and z each represent a molar percentage of a respective constituent polymerizing unit, with the proviso that x, y and z satisfy relationships 30≦x≦60, 5≦y≦70 and 0≦z≦65.

14. The anti-glare anti-reflection film as defined in claim 1,
wherein the low refractive index layer comprises a hollow particulate silica.

15. A process for the production of an anti-glare anti-reflection film as defined in claim 1, comprising:
(1) preparing a coating composition for anti-glare anti-reflection layer as a coating composition having a viscosity of from 3 mPa·s to 10 mPa·s; and
(2) adding a polymer compound to the coating composition to raise the viscosity thereof by 3 mPa·s to 10 mPa·s from before the addition.

16. A polarizing plate comprising:
a polarizing layer; and
two sheets of protective films for the polarizing layer,
wherein at least one of the two sheets of the protective films is an anti-glare anti-reflection film defined in claim 1.

17. An image display device comprising an image display surface on which an anti-glare anti-reflection film as defined in claim 1 is disposed.

18. An image display device comprising an image display surface on which a polarizing plate as defined in claim 16 is disposed.

19. The image display device as defined in claim 17, which is a TN, STN, IPS, VA or OCB mode transmission, reflection or semi-transmission type liquid crystal display device.

20. The image display device as defined in claim 18, which is a TN, STN, IPS, VA or OCB mode transmission, reflection or semi-transmission type liquid crystal display device.
